(19) United States
(12) Patent Application Publication
(10) Pub. No.: US 2004/0183457 A1
(43) Pub. Date: Sep. 23, 2004

(54) Image forming apparatus

(76) Inventors: Hirohito Kondo, Osaka (JP); Hideki Ishida, Osaka (JP); Eiji Tatsumi, Osaka (JP)

Correspondence Address: SMITH, GAMBRELL & RUSSELL, LLP, 1850 M STREET, N.W., SUITE 800, WASHINGTON, DC, 20036, US

(21) Appl. No.: 10/730,908

(22) Filed: Dec. 10, 2003

(30) Foreign Application Priority Data
Dec. 12, 2002 (JP) 2002-360612
Dec. 12, 2002 (JP) 2002-360688
Dec. 12, 2002 (JP) 2002-360717
Dec. 12, 2002 (JP) 2002-360748
Dec. 12, 2002 (JP) 2002-360792
Dec. 12, 2002 (JP) 2002-360883
Dec. 12, 2002 (JP) 2002-360838

(51) Int. Cl. G09G 3/10

(52) U.S. Cl. 315/169.3

(57) ABSTRACT

An image forming apparatus is provided that is capable of realizing suppression of density non-uniformity of an image and improved image quality. The image forming apparatus has an LED array control unit for driving and controlling an LED print head. The LED array control unit includes a characteristic data storing unit for storing a plurality of pieces of characteristic data regarding each of a plurality of LED elements forming an LED array, a drive current correction data computing unit, an image signal processing unit, and an image data correction computing unit. The drive current correction data computing unit reads out characteristic data from the characteristic data storing means, and calculates drive current correction data. The image data correction computing unit corrects the image data inputted from the image signal processing unit with the drive current correction data, and outputs the corrected image data to the print head.

### BACKGROUND OF THE INVENTION

1. Field of the Invention

The present invention relates to an image forming apparatus using an LED (Light Emitting Diode) print head as light exposing means such as an electrophotographic printer, a facsimile apparatus or a copier.

2. Description of the Prior Art

In recent years, attention is being paid to an electrophotographic image forming apparatus using an LED array as optical writing means in order to realize reduction in size, simplification and the like of an apparatus. In the electrophotographic image forming apparatus, an LED print head used for exposing a photoreceptor has an LED array formed by linearly arranging a plurality of LED elements. The LED elements are selectively allowed to emit light on the basis of image data.

It is, however, impossible to manufacture the plurality of LED elements forming the LED array so that all of the LED elements have the same light emission characteristic. Even when current of the same magnitude is applied to all of the LED elements, the light quantities of the LED elements varies. That is, there are variations in the light quantities for each of the LED elements. It causes non-uniformity in image density.

Therefore, there has been proposed an LED print head which is corrected so as to suppress the variations in the light quantities and make the light quantities of the LED elements uniform. For example, there has been proposed a technique in which, for the purpose of making light emission outputs of an LED printer uniform and improving the printing quality, laser beam trimming is performed to adjust a resistance value, thereby controlling current to be supplied to the LED elements and making the light quantities constant (for example, see Japanese Laid-Open Patent Application No. 5-4376 (1993) [pages 3-4, FIGS. 6 to 8]). There has been also proposed another technique in which, for the purpose of making an adjusting work unnecessary, that is performed at the time of assembling a head having variations in light quantities into a product or replacing an LED print head, correction data to make the light emission quantities of the LED elements constant is preliminarily obtained, an ROM in which the correction data is stored is provided in the LED print head, and the LED elements selectively emit light using the correction data at the time of printing an image (for example, see Japanese Laid-Open Patent Application No. 5-50653 (1993) [pages 3-4, FIG. 1]).

Since light image data emitted from the LED elements forms as a latent image on the photoreceptor via a lens array, in the conventional image forming apparatus having the LED print head, even when the light quantities of the LED elements are made constant, the diameter of a dot to be formed varies according to the LED elements due to variations in the optical characteristics of the lens array. It can be therefore said that it is impossible to make the light quantity distributions of all of dots uniform. As a result, a disadvantage occurs such that a vertical streak appears on an image. For example, as shown in FIG. 26, even when the light quantity of an LED element a′ and that of an LED element b′ are the same, dot diameters Sₐ′ and S_{b}′ of the LED elements a′ and b′ at a development threshold are different from each other (Sₐ′<S_{b}′). Consequently, a latent image dot of the LED element b′ having the larger dot diameter at the development threshold is larger than that of the LED element a′ and is expressed darker on an image.

### SUMMARY OF THE INVENTION

An object of the present invention is to provide an image forming apparatus which can solve the above-mentioned problems and can realize suppressed density non-uniformity of an image and improved image quality.

To achieve the above-mentioned object, the present invention provides an image forming apparatus comprising: an LED print head having an LED array formed by a plurality of LED elements which are controlled to emit light in accordance with image data and a drive circuit for driving the plurality of LED elements; and an LED array controller for driving and controlling the LED print head, wherein the LED array controller includes: a characteristic data memory for storing a plurality of pieces of characteristic data of each of the plurality of LED elements; and a drive current correction data calculator for reading out the characteristic data from the characteristic data memory and calculating drive current correction data for each of the plurality of LED elements on the basis of the characteristic data.

With such a configuration, drive current correction data for each of the LED elements is calculated on the basis of characteristic data of the LED element as a cause of density non-uniformity of an image, and the LED element is controlled to emit light on the basis of the data. Consequently, differences in display density among the plurality of LED elements forming the LED array can be suppressed with high precision, and density non-uniformity of an image can be suppressed. As a result, occurrence of a vertical streak on an image can be reduced efficiently.

In order to achieve the object, the present invention also provides an image forming apparatus comprising: an LED print head having an LED array formed by a plurality of LED elements which are controlled to emit light in accordance with image data and a drive circuit for driving the plurality of LED elements; and an LED array controller for driving and controlling the LED print head, wherein the LED array controller includes: a characteristic data memory for storing a plurality of pieces of characteristic data of each of the plurality of LED elements; and a light emission time correction data calculator for reading out the characteristic data from the characteristic data memory, and calculating light emission time correction data for each of the plurality of LED elements on the basis of the characteristic data.

With such a configuration, light emission time correction data for each of the LED elements is calculated on the basis of characteristic data of the LED element as a cause of density non-uniformity of an image, and the LED element is controlled to emit light on the basis of the data. Consequently, differences in display density among the plurality of LED elements forming the LED array can be suppressed with high precision, and density non-uniformity of an image can be suppressed. As a result, occurrence of a vertical strip on an image can be reduced efficiently.

### BRIEF DESCRIPTION OF THE DRAWINGS

The above and other objects and features of this invention will become more clear from the following description, taken in conjunction with the preferred embodiments with reference to the accompanying drawings in which:

FIG. 1 is a schematic diagram showing the general configuration of an image forming apparatus common to embodiments of the present invention;

FIG. 2 is a schematic diagram showing the schematic configuration of an LED array exposing device in the image forming apparatus common to the embodiments of the present invention;

FIG. 3 is a schematic diagram showing a case where the LED array exposing device is assembled in the image forming apparatus;

FIG. 4 is a block diagram showing the configuration of an LED array control unit in the image forming apparatus according to a first embodiment of the present invention;

FIG. 5 is a block diagram showing the configuration of a driving circuit of an LED print head in the image forming apparatus common to the embodiments of the present invention;

FIG. 6 is a block diagram showing a process of computing drive current correction data in the image forming apparatus according to the first embodiment of the present invention;

FIG. 7 is a block diagram showing a process of computing the drive current correction data in the image forming apparatus according to the first embodiment;

FIG. 8 is a flowchart showing the procedure of light emission control of an LED element in the image forming apparatus according to the first embodiment;

FIG. 9 is a block diagram showing the configuration of an LED array control unit in an image forming apparatus according to a second embodiment of the present invention;

FIG. 10 is a flowchart showing the procedure of light emission control of LED elements in the image forming apparatus according to the second embodiment;

FIG. 11 is a block diagram showing the configuration of an LED array control unit in an image forming apparatus according to a fourth embodiment of the present invention;

FIG. 12 is a block diagram showing a process of arranging characteristic data by an LED element characteristic data arranging unit in the image forming apparatus according to the fourth embodiment;

FIG. 13 is a block diagram showing a process of storing characteristic data by an LED element characteristic data storing unit in the image forming apparatus according to the fourth embodiment;

FIG. 14 is a flowchart showing the procedure of light emission control of LED elements in the image forming apparatus according to the fourth embodiment;

FIG. 15 is a block diagram showing the configuration of an LED array control unit in an image forming apparatus according to a fifth embodiment of the present invention;

FIG. 16 is a flowchart showing the procedure of the light emission control of the LED elements in the image forming apparatus according to the fifth embodiment;

FIG. 17 is a block diagram showing the configuration of an LED array control unit in an image forming apparatus according to a sixth embodiment of the present invention;

FIG. 18 is a block diagram showing a process of computing drive current correction data in the image forming apparatus according to the sixth embodiment;

FIG. 19 is a block diagram showing a process of computing the drive current correction data in the image forming apparatus according to the sixth embodiment;

FIG. 20 is a block diagram showing the configuration of an LED array control unit in an image forming apparatus according to a seventh embodiment of the present invention;

FIG. 21 is a block diagram showing the configuration of an LED array control unit in an image forming apparatus according to a ninth embodiment of the present invention;

FIG. 22 is a block diagram showing the configuration of an LED array control unit in an image forming apparatus according to a tenth embodiment of the present invention;

FIGS. 23A and 23B are views showing the relationship between intensity of light exposure of an LED element and the beam diameter at a development threshold in each of the image processing apparatuses according to the embodiments of the present invention;

FIGS. 24A and 24B are views showing the relationship between the beam diameter of an LED element and drive current correction data calculated in the image processing apparatus according to the third embodiment of the present invention;

FIGS. 25A and 25B are views showing the relationship between the beam diameter of an LED element and light emission time correction data calculated in the image processing apparatus according to the eighth embodiment of the present invention; and

FIG. 26 is a view showing the relationship between gradations of LED elements and the beam diameters at a development threshold in a conventional image processing apparatus.

### DESCRIPTION OF THE PREFERRED EMBODIMENTS

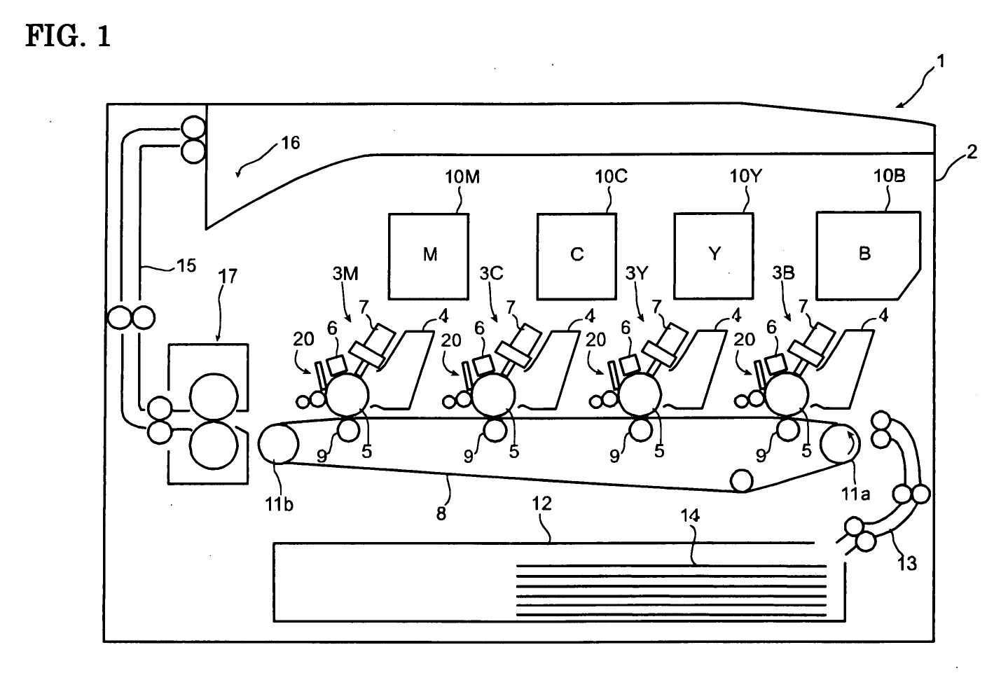

Hereinafter, embodiments of the present invention will be described in detail with reference to the drawings. FIG. 1 is a schematic diagram showing the general configuration of an image forming apparatus common to embodiments of the present invention. The image forming apparatus shown in FIG. 1 comprises: a color printer 1 as an example of the image forming apparatus; a casing 2; image forming units 3B, 3Y, 3C and 3M for black, yellow, cyan and magenta, respectively; toner hoppers 10B, 10Y, 10C and 10M for black, yellow, cyan and magenta, respectively; a paper cassette 12 for housing paper sheets 14; a paper feeding guide 13; conveyor belt driving rollers 11a and 11b; a conveyer belt 8; a transfer roller 9; a fixing unit 17; a paper ejecting guide 15; and a paper ejected area 16. Each of the image forming units 3B, 3Y, 3C and 3M for the respective colors is configured by a developer 4, a photoreceptor 5 as an image carrier, a main charger 6, an LED print head 7, a cleaning unit 20 and the like.

In the color printer 1, on the photoreceptor 5 charged by the main charger 6, an electrostatic latent image is formed by the LED print head 7 and developed by the developer 4, thereby forming a toner image as a visible image. Such a process is performed for each of the colors of black, yellow, cyan and magenta. The paper sheet 14 fed from the paper cassette 12 is guided by the paper feeding guide 13 and attracted to the top face of the conveyer belt 8 which rotates in the counterclockwise direction. When the paper sheet 14 passes immediately below the image forming units 3B, 3Y, 3C and 3M for the respective colors, toner images of the respective colors are sequentially transferred onto the paper sheet 14 by the transfer rollers 9. In such a manner, the toner of four colors by which a full color image is formed on the paper sheet 14 is fixed when the paper sheet 14 passes the fixing unit 17. After that, the paper sheet 14 is guided by the paper ejecting guide 15 and ejected to the paper ejected area 16.

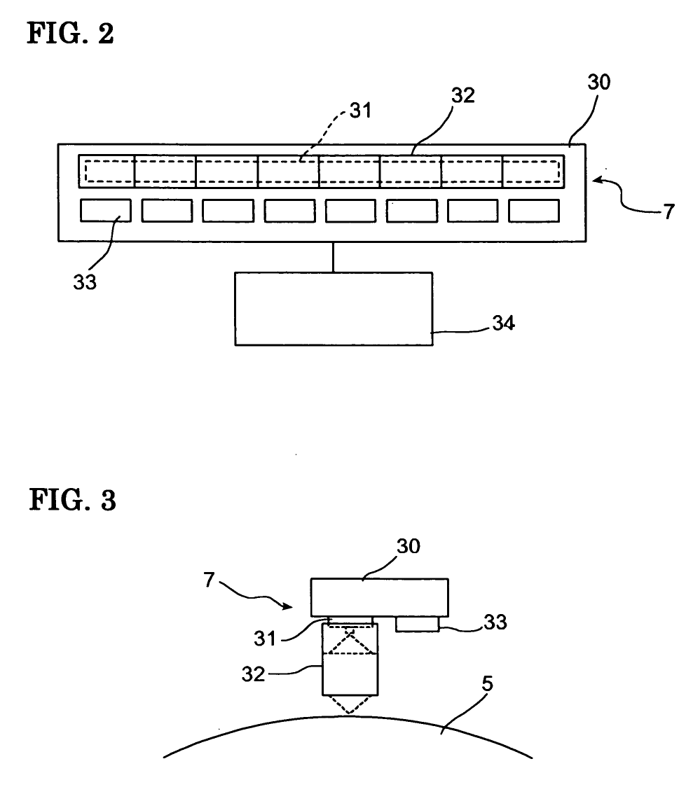

With reference to FIG. 2, the LED print head 7 provided in the color printer 1 will now be described. FIG. 2 is a schematic diagram showing the schematic configuration of an LED array print head in the image forming apparatus common to the embodiments of the present invention. In FIG. 2, the LED print head 7 is configured by: an LED array 31 consisting of a plurality of LEDs arranged linearly on a substrate 30 having wiring and controlled to emit light in accordance with image data; a lens array 32 disposed above the LED array 31 and forming an erect image of 1× magnification; and drive circuits 33 for driving the plurality of LED elements forming the LED array 31. Herein, the substrate 30, the lens array 32 and the like are held by a holding member (not shown). An LED array control unit 34 for driving and controlling the LED print head 7 is provided externally.

FIG. 3 is a schematic diagram showing a case where the LED print head 7 is assembled in the image forming apparatus. In FIG. 3, reference numeral 5 denotes the photoreceptor having a drum shape. Broken lines show a state where the lens array 32 receives and deflects light emitted from the LED elements and transmits the deflected light, and an image is formed by the light on the drum surface.

As described above, in correspondence with an image signal transmitted from an external PC (not shown) or the like to the color printer 1 in FIG. 1, each of the LED elements is driven. Light emitted from the driven LED element falls as a dot on the surface of the photoreceptor 5 via the lens array 32, so that an image is formed. The image forming apparatus is formed so that the higher exposure energy on the photoreceptor 5 (or the LED element light emission energy) is, the higher the density of a pixel becomes. The exposure energy (or the LED element light emission energy) is expressed by “light emission intensity (=drive current) of an LED element×light emission time (=drive current supply time)”.

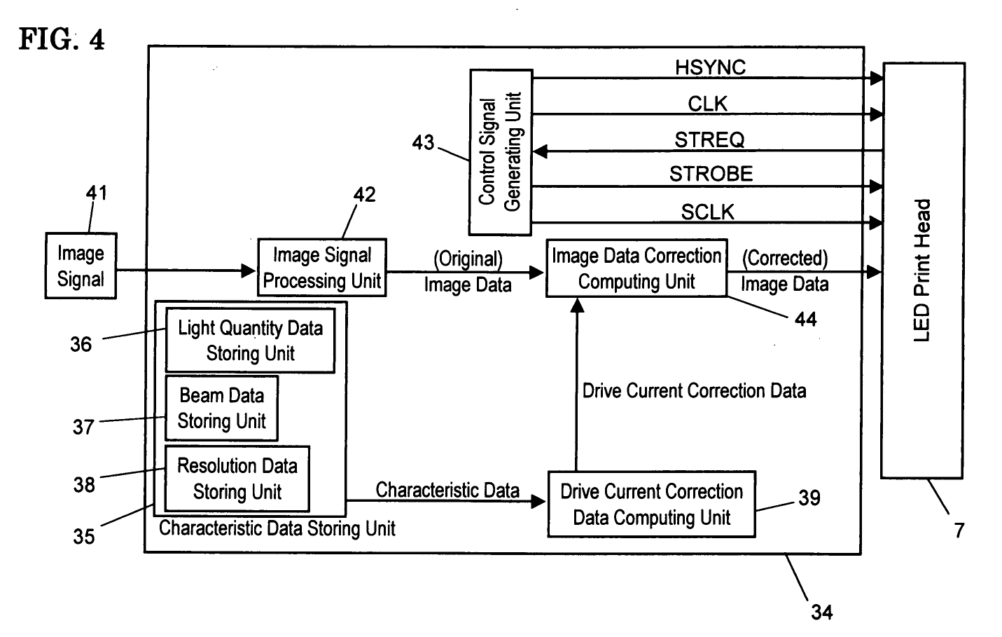

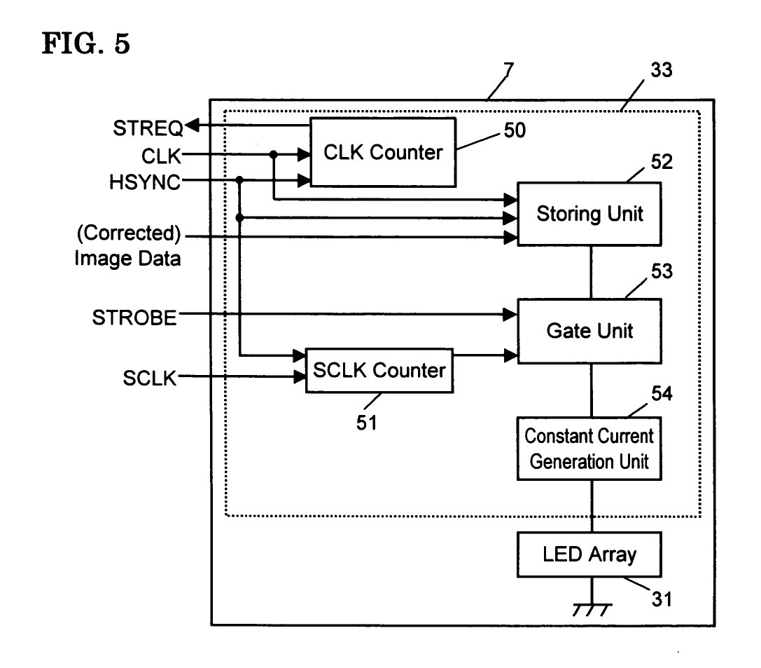

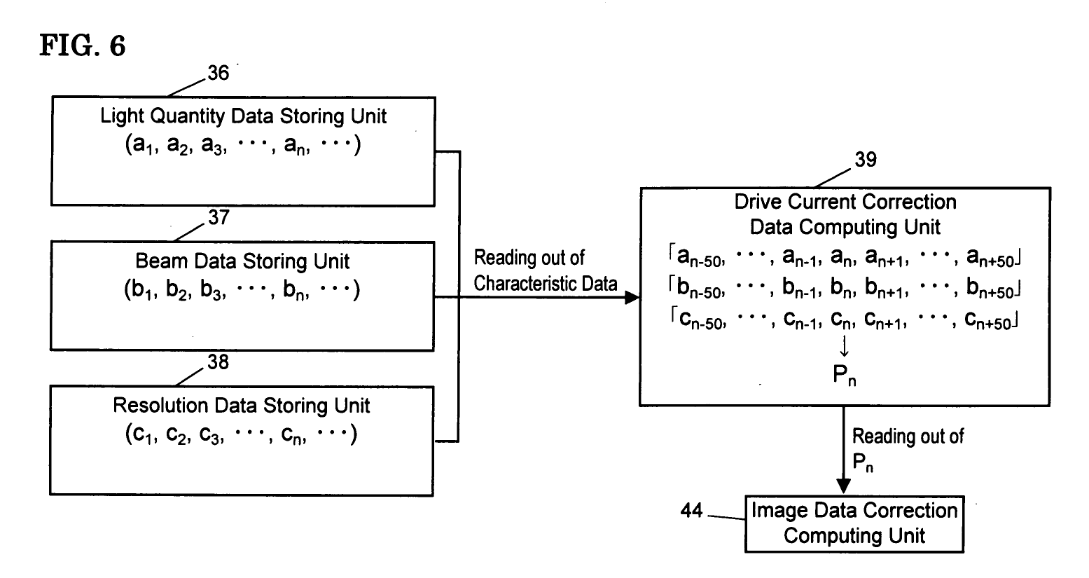

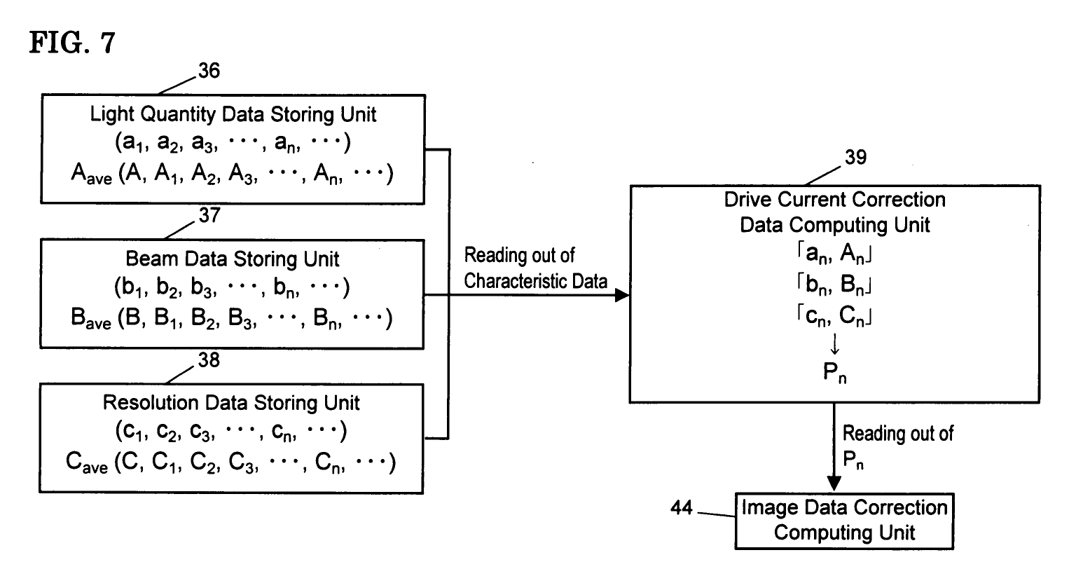

The operation of the LED array control unit and the operation of the drive circuit of the LED print head will now be described with reference to FIGS. 4 to 7. FIG. 4 is a block diagram showing the configuration of the LED array control unit in the image forming apparatus according to the first embodiment of the present invention. FIG. 5 is a block diagram showing the configuration of the drive circuit of the LED print head in the image forming apparatus common to the embodiments of the present invention. FIGS. 6 and 7 are block diagrams each showing a process of computing drive current correction data in the image forming apparatus of the first embodiment.

The LED array control unit 34 is used for driving and controlling the LED print head 7 and is configured by a characteristic data storing unit 35, a drive current correction data computing unit 39, an image signal processing unit 42, a control signal generating unit 43 and an image data correction computing unit 44.

The image signal processing unit 42 is means for properly performing an imaging process such a gradation process on an image signal 41 transmitted from an external apparatus such as a frame memory or a scanner to the LED array control unit 34, thereby converting the image signal 41 into image data. The image data is data for indicating pixel density separated to each of the colors of black, yellow, cyan and magenta, and is m-bit digital data indicative of drive current (light emission intensity) of an LED element and light emission time (drive current supply time). The image data processed by the image signal processing unit 42 is outputted to the image data correction computing unit 44.

The characteristic data storing unit 35 is means for storing a plurality of pieces of characteristic data preliminarily measured with respect to each of the plurality of LED elements forming the LED array 31, and is configured by, as shown in FIG. 4: a light quantity data storing unit 36 for storing light quantity data of each of the LED elements as characteristic data; a beam storing unit 37 for storing, as characteristic data, data regarding a beam emitted from each of the LED elements, for example, data regarding a beam diameter and a beam area; and a resolution data storing unit 38 for storing, as characteristic data, data indicative of resolution of each of the LED elements, for example, MTF (Modulation Transfer Function) data. The characteristic data storing unit 35 is configured by, for example, an ROM (Read Only Memory). Alternately, to address a change in characteristics of each of the LED elements, a rewritable PROM (for example, an EPROM which erases data with ultraviolet light or an EEPROM which electrically erases data) may be employed.

The drive current correction data computing unit 39 is connected to the characteristic data storing unit 35. The drive current correction data computing unit 39 reads out the characteristic data stored in the light quantity data storing unit 36, the beam data storing unit 37 and the resolution data storing unit 38 which are provided in the characteristic data storing unit 35, and calculates drive current correction data P for each of the plurality of LED elements forming the LED array 31 on the basis of the characteristic data in accordance with a predetermined arithmetic expression. The drive current correction data P calculated by the drive current correction data computing unit 39 is outputted to the image data correction computing unit 44.

The drive current correction data P is, as will be described later, data used at the time of changing intensity of light exposure of each of the LED elements by changing the drive current of each of the LED elements forming the LED array 31. For example, in the case of correcting the drive current of a dot 1 (the first LED element), drive current correction data P₁ is used. In the case of correcting the drive current of a dot n (the n-th LED element), drive current correction data Pₙ is used.

Herein, the drive current correction data computing unit 39 in the first embodiment calculates drive current correction data by using not only the characteristic data of a predetermined LED element to be corrected but also the characteristic data of a plurality of LED elements in a predetermined range including the predetermined LED element to be corrected. However, the present invention may be modified to calculate the drive current correction data by using only the characteristic data of the predetermined LED element to be corrected.

In the first embodiment, as shown in FIG. 6, for example, in the case of calculating the drive current correction data Pₙ for correcting the drive current of the dot n (the n-th LED element) and using characteristic data of 100 LED elements arranged before and after the dot n (specifically, 50 LED elements from a dot n−1 to a dot n−50 and 50 LED elements from a dot n+1 to a dot n+50), the drive current correction data computing unit 39 reads out, from the characteristic data storing unit 35, the characteristic data regarding the dot n stored in the light quantity data storing unit 36, the beam data storing unit 37 and the resolution data storing unit 38 (light quantity data aₙ, beam data bₙ and resolution data cₙ), characteristic data regarding from the dot n−1 to the dot n−50 (light quantity data aₙ₋₁ to aₙ₋₅₀, beam data bₙ₋₁ to bₙ₋₅₀ and resolution data cₙ₋₁ to cₙ₋₅₀), and characteristic data regarding the dot n+1 to the dot n+50 (light quantity data aₙ₊₁ to aₙ₊₅₀, beam data bₙ₊₁ to bₙ₊₅₀ and resolution data cₙ₊₁, to cₙ₊₅₀) out of the plurality of pieces of characteristic data stored in the characteristic data storing unit 35. Subsequently, according to a predetermined arithmetic expression, the drive current correction data Pₙ for the dot n is calculated on the basis of the read characteristic data regarding a predetermined LED element (that is, dot n) and the read characteristic data regarding each of the plurality of LED elements (specifically, the 50 LED elements from the dot n−1 to the dot n−50 and the 50 LED elements from the dot n+1 to the dot n+50) in the predetermined range including the predetermined LED element to be corrected. Subsequently, as shown in FIG. 6, the drive current correction data Pₙ calculated by the drive current correction data computing unit 39 is read out by the image data correction computing unit 44.

As described above, at the time of computing the drive current correction data P in the drive current correction data computing unit 39, by using not only the characteristic data of the predetermined LED element to be corrected but also the characteristic data of the plurality of LED elements in the predetermined range including the predetermined LED element to be corrected, high-precision drive current correction data P can be obtained. As a result, image data can be corrected with high precision.

Alternately, at the time of computing the drive current correction data P by the drive current correction data computing unit 39, drive current correction data may be calculated by using not only the characteristic data of the predetermined LED element to be corrected but also an average value of characteristic data of all of the LED elements forming the LED array 31 or an average value of characteristic data of a plurality of LED elements in a predetermined range including the predetermined LED element to be corrected.

In this case, as shown in FIG. 7, in the light quantity data storing unit 36, Aₐᵥₑ is prestored, which is constructed by an average value A of light quantity data of all of LED elements forming the LED array 31 and average values (for example, A₁ for the dot 1 and Aₙ for the dot n) of the light quantity data of a plurality of LED elements in a predetermined range including the predetermined LED element to be corrected. In the beam data storing unit 37, Bₐᵥₑ is prestored, which is constructed by an average value B of beam data of all of LED elements forming the LED array 31 and average values (for example, B, for the dot 1 and Bₙ for the dot n) of the beam data of a plurality of LED elements in a predetermined range including the predetermined LED element to be corrected. In the resolution data storing unit 38, Cₐᵥₑ is prestored, which is constructed by an average value C of resolution data of all of LED elements forming the LED array 31 and average values (for example, C₁ for the dot 1 and Cₙ for the dot n) of the resolution data of a plurality of LED elements in a predetermined range including the predetermined LED element to be corrected.

Herein, methods of driving each of the LED elements forming the LED print head 31 include: a static driving method for performing light emission control on all of the LED elements in a lump; and a dynamic driving method for performing light emission control on the LED elements on a block unit basis, wherein the blocks are obtained by dividing the LED elements. For example, in the case of using the dynamic driving method and calculating the drive current correction data Pₙ for correcting the drive current of the dot n, as shown in FIG. 7, the drive current correction data computing unit 39 reads out characteristic data (light quantity data aₙ, beam data bₙ and resolution data cₙ) of the dot n and average values (Aₙ, Bₙ and Cₙ) of the characteristic data of a plurality of LED elements in a predetermined range including the dot n to be corrected out of the characteristic data stored in the light quantity data storing unit 36, beam data storing unit 37 and resolution data storing unit 38. Subsequently, according to a predetermined arithmetic expression, on the basis of the read characteristic data of the predetermined LED element (that is, the dot n) and the read average values of the characteristic data of the plurality of LED elements in the predetermined range including the predetermined LED element to be corrected, the drive current data computing unit 39 calculates the drive current correction data Pₙ for the dot n. As shown in FIG. 7, the drive current correction data Pₙ calculated by the drive current correction data computing unit 39 is read out by the image data correction computing unit 44.

In the case of using the static driving method and calculating the drive current correction data Pₙ for correcting the drive current of the dot n, the drive current correction data computing unit 39 reads out characteristic data (light quantity data aₙ, beam data bₙ and resolution data cₙ) of the dot n out of the characteristic data stored in the light quantity data storing unit 36, beam data storing unit 37 and resolution data storing unit 38, and average values (A, B and C) of the characteristic data of all of LED elements forming the LED array 31. Subsequently, according to a predetermined arithmetic expression, on the basis of the read characteristic data of the predetermined LED element (that is, the dot n) and the read average values of the characteristic data of all of the LED elements forming the LED array 31, the drive current data computing unit 39 calculates the drive current correction data Pₙ for the dot n. As shown in FIG. 7, the drive current correction data Pₙ calculated by the drive current correction data computing unit 39 is read out by the image data correction computing unit 44.

As described above, at the time of computing the drive current correction data P in the drive current correction data computing unit 39, by using not only the characteristic data of a predetermined LED element to be corrected but also an average value of characteristic data of all of LED elements forming the LED array 31 or an average value of the characteristic data regarding a plurality of LED elements in a predetermined range including the predetermined LED element to be corrected, the high-precision drive current correction data P adapted to the driving method can be obtained and, as a result, image data can be corrected with high precision.

The image data correction computing unit 44 corrects the image data outputted from the image signal processing unit 42. In the first embodiment, the drive current of the image data outputted from the image signal processing unit 42 is corrected using the drive current correction data P outputted from the drive current correction data computing unit 39. Specifically, the image data correction computing unit 44 corrects m-bit digital data indicative of the drive currents of the LED elements forming the LED array 31 out of the image data outputted from the image signal processing unit 42 in accordance with the drive current correction data P outputted from the drive current correction data computing unit 39. The corrected image data is outputted to the LED print head 7 as shown in FIG. 4.

The drive circuit 33 of the LED print head 7 has, as shown in FIG. 5: a CLK counter 50 for counting a clock signal CLK; an SCLK counter 51 for counting a strobe clock signal SCLK; a storing unit 52 for temporarily storing corrected image data indicative of pixel density; a gate unit 53 which is closed/opened according to the logic of an output time control signal STROBE; and a constant current generating unit 54 for generating drive current of the LED array 31.

The drive circuit 33 of the LED print head 7 having the above-mentioned configuration is initialized at the falling edge of a horizontal sync signal HSYNC inputted from the control signal generating unit 43, and starts receiving the clock signal CLK inputted also from the control signal generating unit 43 and corrected image data which is inputted synchronously with the clock signal CLK.

The storing unit 52 has a shift register and a latch circuit and, in order to convert corrected image data to be inputted, temporarily stores data necessary for light emission of the LED array 31. Herein, in the case of employing the static driving method, data of all of LED elements is temporarily stored. In the case of employing the dynamic driving method, data of one block is temporarily stored.

The CLK counter 50 determines whether temporary storage of image data in the storing unit 52 has been completed or not on the basis of the number of counting the clock signal CLK and, at the time point that the completion is determined, outputs a light emission timing control signal STREQ indicating that light emission is prepared to the control signal generating unit 43.

When the output time control signal STROBE is set to an active level (low level) by the control signal generating unit 43 which has received the light emission timing control signal STREQ and the strobe clock signal SCLK is started to be inputted, the SCLK counter 51 starts counting the strobe clock signal SCLK and the gate unit 53 is opened. Therefore, to each of the LED elements forming the LED array 31, drive current based on the drive current correction data P stored in the storing unit 52 is passed only by the light emission time based on the image data stored in the storing unit 52, and the photoreceptor 5 is exposed.

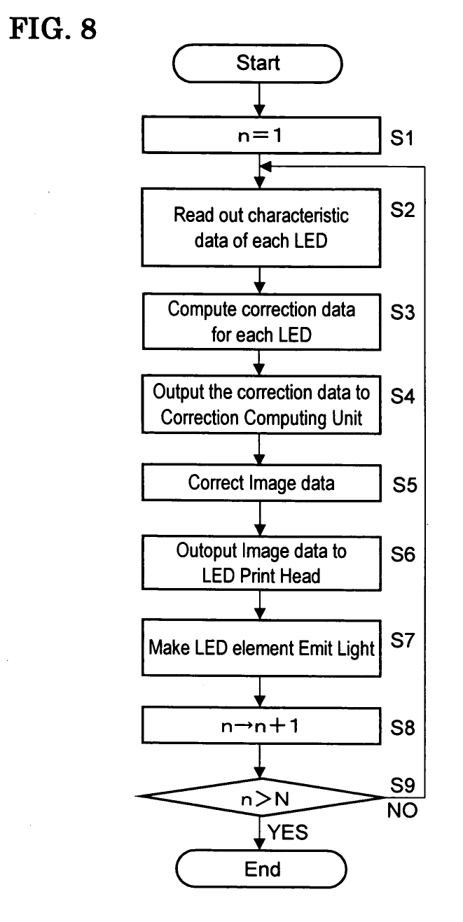

FIG. 8 is a flowchart showing the procedure of light emission control of an LED element in the first embodiment. In the control procedure, first, in order to set the first line as an object out of the total number N of lines, n is set to 1 (n=1) (step S1). Next, characteristic data necessary to compute the drive current correction data P is read out from the characteristic data storing unit 35 (step S2). In the drive current correction data computing unit 39, the drive current correction data P for each of the LED elements is computed (step S3). The calculated drive current correction data P is then outputted to the image data correction computing unit 44 (step S4). In the image data correction computing unit 44, the image data is corrected (step S5). The corrected image data is then outputted to the LED print head 7 (step S6), and the LED elements are controlled to emit light in accordance with the corrected image data (step S7). Further, in order to set the next line n as an object, n is incremented only by +1 (step S8), and whether n does not exceed the total number N of lines to be printed or not is checked (step S9). When n does not exceed the total number N, the process is similarly repeated with respect to the line n (steps S2 to S9).

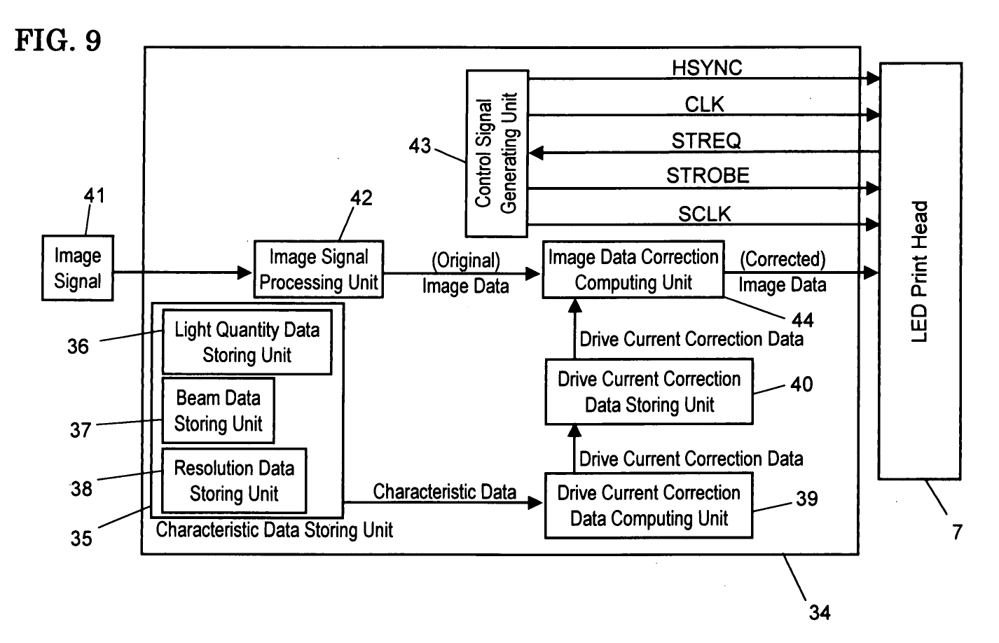

In the first embodiment, after the drive current correction data P is calculated by the drive current correction data computing unit 39, the calculated data is directly outputted to the image data correction computing unit 44. As a modification, as shown in FIG. 9, a configuration may also be employed that the drive current correction data storing unit 40 for storing the drive current correction data P calculated by the drive current correction data computing unit 39 is separately provided and is connected to the drive current correction data computing unit 39 and the image data correction computing unit 44. This configuration will be described below as a second embodiment.

In the second embodiment, as shown in FIG. 9, the drive current correction data storing unit 40 reads out the drive current correction data P computed by the drive current correction data computing unit 39 described with reference to FIGS. 6 and 7 from the drive current correction data computing unit 39, stores the drive current correction data P, and outputs the drive current correction data P to the image data correction computing unit 44. In order to address a change in the drive current correction data P based on a characteristic change of each of the LED elements, a rewritable PROM (for example, an EPROM which erases data with ultraviolet light or an EEPROM which electrically erases data) may be employed as the drive current correction data storing unit 40. The functions of the other parts are similar to those of the above-mentioned first embodiment, so that their detailed description will not be repeated herein.

With such a configuration, even in the case where it takes long time to compute the drive current correction data P, since the preliminary computed drive current correction data P is stored in the drive current correction data storing unit 40, the drive current correction data P can be promptly read out by the image data correction computing unit 44. As a result, image data correction by the image data correction computing unit 44 can be performed at higher speed.

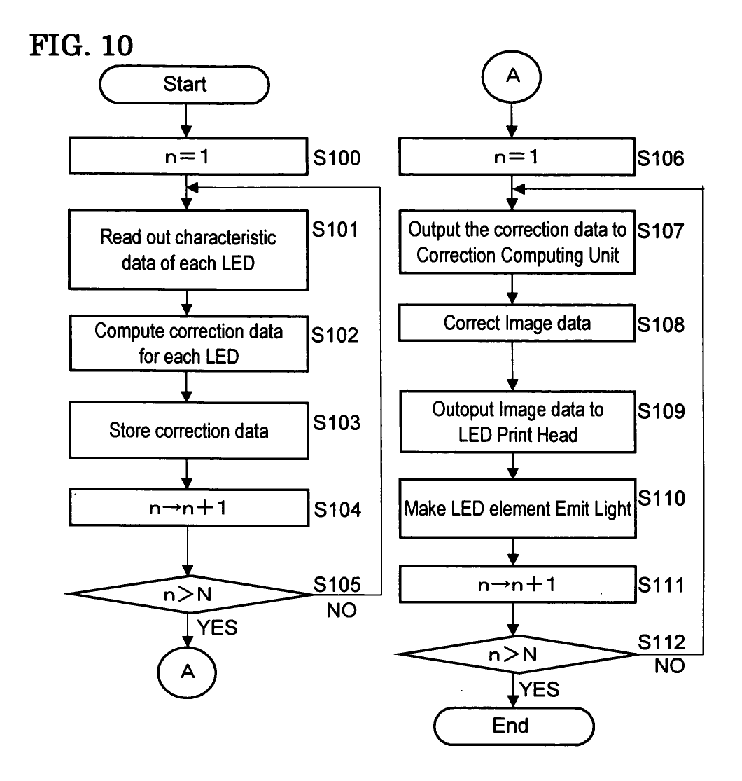

The procedure of light emission control of an LED element in this case is performed according to the flowchart of FIG. 10. Specifically, first, in order to set the first line as an object out of the total number N of lines, n is set to 1 (n=1) (step S100). Next, characteristic data necessary to compute the drive current correction data P is read out from the characteristic data storing unit 35 (step S101). In the drive current correction data computing unit 39, the drive current correction data P for each of the LED elements is computed (step S102). The calculated drive current correction data P is then stored in the drive current correction data storing unit 40 (step S103). Further, in order to set the next line n as an object, n is incremented only by +1 (step S104) and whether n exceeds the total number N of lines to be printed or not is checked (step S105). When n does not exceed the total number N, the process is similarly repeated with respect to the line n, and the drive current correction data P is stored in the drive current correction data storing unit 40 for all of the lines (steps S101 to S105).

Next, in order to set the first line as an object out of the total number N of lines, n is set again to 1 (n=1) (step S106). The drive current correction data P stored in the drive current correction data storing unit 40 is outputted to the image data correction computing unit 44 (step S107) and image data is corrected in the image data correction computing unit 44 (step S108). The corrected image data is then outputted to the LED print head 7 (step S109) and the LED elements are controlled to emit light in accordance with the corrected image data (step S110). Further, in order to set the next line n as an object, n is incremented only by +1 (step S111) and whether n exceeds the total number N of lines to be printed or not is checked (step S112). When n does not exceed the total number N, the process is similarly repeated with respect to the line n (steps S107 to S112).

A third embodiment of the present invention will now be described. The third embodiment has a feature in that an arithmetic expression suitable for calculating the drive current correction data P for each of the LED elements in the drive current correction data computing unit 39 in the first and second embodiments is embodied.

The drive current correction data P is calculated by, for example, the following arithmetic expression (1) in the drive current correction data computing unit 39 for the purpose of stabilizing calculation precision.

Pₙ=aₙ+α·(bₙ−Bₐᵥₑ)/Bₐᵥₑ+β·(cₙ−Cₐᵥₑ)/Cₐᵥₑ Equation (1)

Pₙ denotes drive current correction data of the n-th LED element. aₙ denotes drive current reference data of the n-th LED element for making the light quantities for the LED elements substantially constant and is stored in the light quantity data storing unit 36. bₙ denotes data regarding a beam of the n-th LED element (for example, the beam diameter and the beam area) and is stored in the beam data storing unit 37. cₙ denotes resolution data of the n-th LED element and is stored in the resolution data storing unit 38. α denotes an arithmetic coefficient regarding a beam and β denotes an arithmetic coefficient regarding resolution. Bₐᵥₑ denotes an average value of data regarding beams of all of the LED elements or an average value of data regarding beams of a plurality of LED elements in a predetermined range including the n-th LED element (for example, 50 LED elements before and 50 LED elements after the n-th LED element), and may be calculated at the time of computation by the drive current correction data computing unit 39 or may be prestored in the beam data storing unit 37. Cₐᵥₑ denotes, similarly to Bₐᵥₑ, an average value of resolution data of all of LED elements or an average value of resolution data of a plurality of LED elements in a predetermined range including the n-th LED element, and may be calculated at the time of computation by the drive current correction data computing unit 39 or may be prestored in the resolution data storing unit 38.

Alternately, the drive current correction data P may be calculated by the following arithmetic expression (2).

Pₙ=aₙ+α·(bₙ−Bₐᵥₑ)/Bₐᵥₑ Equation (2)

Pₙ, aₙ, bₙ, α and Bₐᵥₑ denote similar to the above. Equation (2) is useful in the case where it is unnecessary to consider resolution data of an LED element. In this case, the resolution data storing unit 38 becomes unnecessary. Therefore, there is an advantage that the configuration can be simplified as compared with the case of Equation (1).

Since the functions of the other parts are similar to those of the above-mentioned first and second embodiments, their detailed description will not be repeated herein.

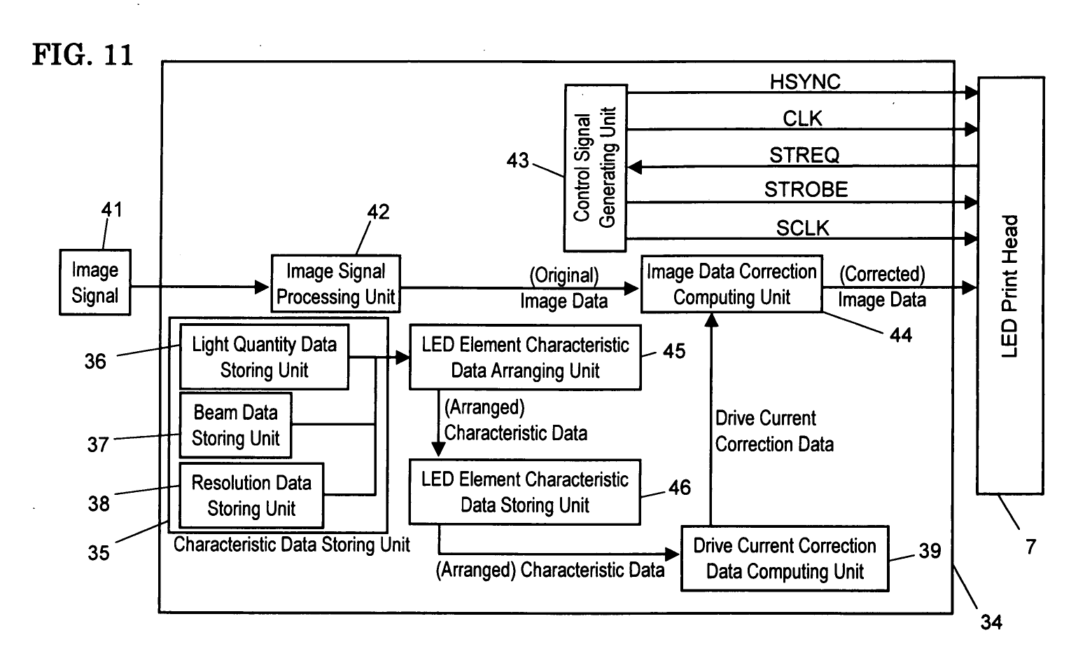

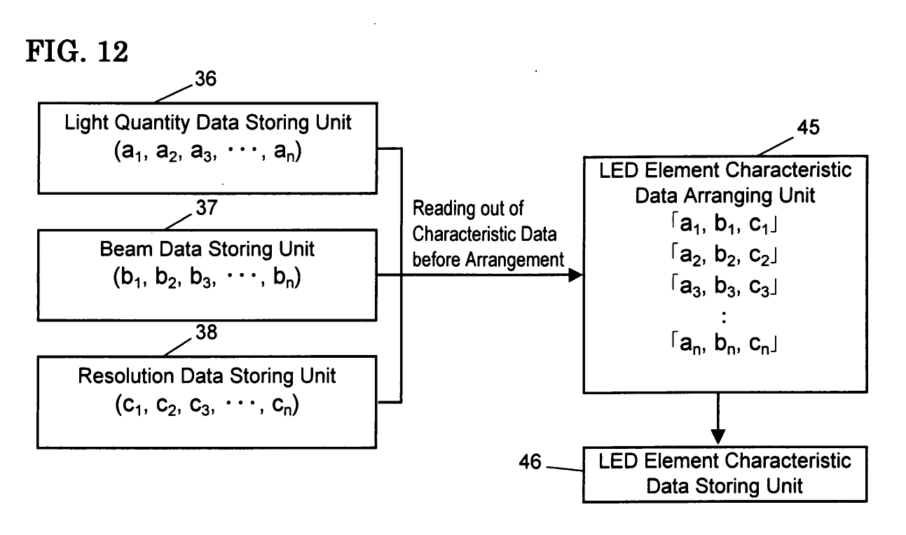

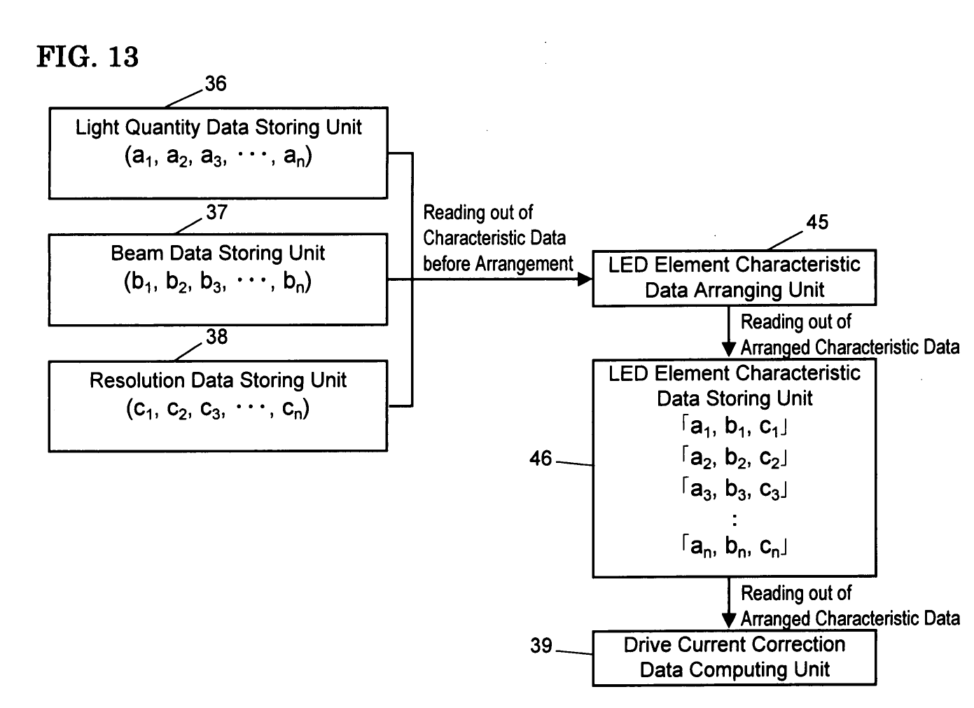

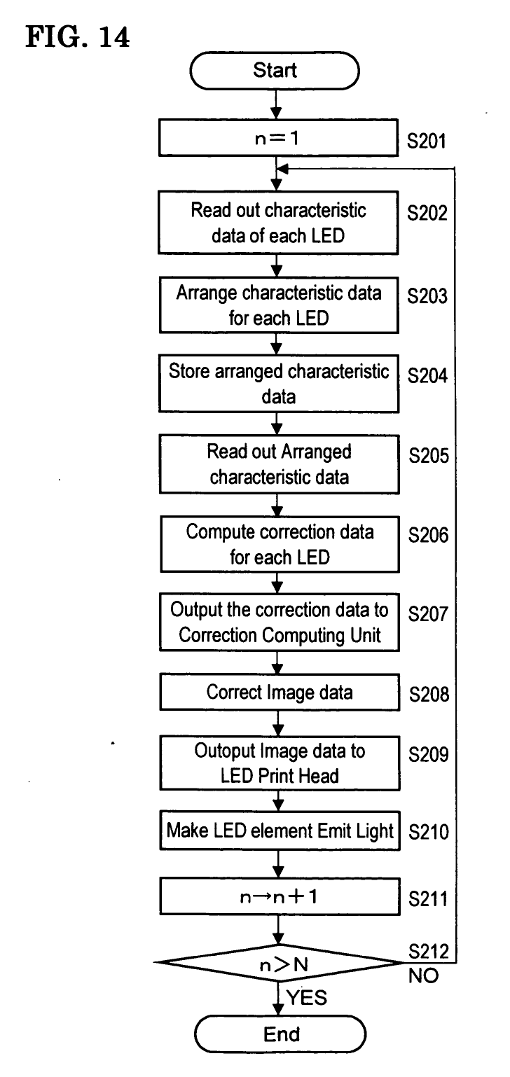

A fourth embodiment of the present invention will now be described with reference to FIGS. 11 to 14. FIG. 11 is a block diagram showing the configuration of an LED array control unit in an image forming apparatus according to a fourth embodiment. FIG. 12 is a block diagram showing a process of arranging characteristic data by an LED element characteristic data arranging unit in the image forming apparatus. FIG. 13 is a block diagram showing a process of storing characteristic data by an LED element characteristic data storing unit in the image forming apparatus. FIG. 14 is a flowchart showing the procedure of light emission control of an LED element in the image forming apparatus. The same reference numerals will be given to the same components as those in FIGS. 1 to 5 and FIG. 9 and their description will not be repeated.

In the fourth embodiment, as shown in FIG. 11, an LED element characteristic data arranging unit 45 is connected to the characteristic data storing unit 35. The LED element characteristic data arranging unit 45 is means for reading out the characteristic data stored in the light quantity data storing unit 36, beam data storing unit 37 and resolution data storing unit 38 which are provided in the characteristic data storing unit 35, and for arranging the read characteristic data for each of the plurality of LED elements forming the LED array 31.

Specifically, as shown in FIG. 12, the LED element characteristic data arranging unit 45 reads out the characteristic data from the light quantity data storing unit 36 for storing the light quantity data of each of the total number n of LED elements forming the LED array 31 (total n pieces of light quantity data in order from the light quantity data a₁ of the dot 1, that is, the first LED element to the light quantity data an of the dot n, that is, the n-th LED element), the beam data storing unit 37 for storing the beam data of each of the total n pieces of LED elements forming the LED array 31 (total n pieces of beam data in order from the beam data b₁ of the dot 1 to the beam data bₙ of the dot n), and the resolution data storing unit 38 for storing the resolution data of each of the total n pieces of LED elements forming the LED array 31 (total n pieces of resolution data in order from the resolution data c₁ of the dot 1 to the resolution data cₙ of the dot n). Then, the LED element characteristic data arranging unit 45 arranges the read characteristic data for each of the total n pieces of LED elements forming the LED array 31. As shown in FIG. 12, with respect to the dot 1, the light quantity data a₁, beam data b₁, and resolution data c₁ each of which is characteristic data of the dot 1 is arranged in a lump. With respect to the dot n, the light quantity data aₙ, beam data bₙ and resolution data cₙ each of which is characteristic data of the dot n is arranged in a lump.

As shown in FIG. 13, the characteristic data of the LED elements from the dot 1 to the dot n, arranged for each of the LED elements by the LED element characteristic data arranging unit 45, is read out by an LED element characteristic data storing unit 46 connected to the LED element characteristic data arranging unit 45, and is stored in the LED element characteristic data storing unit 46.

The drive current correction data computing unit 39 is connected to the LED element characteristic data storing unit 46. As shown in FIGS. 11 and 12, the drive current correction data computing unit 39 reads out the characteristic data arranged for each of the LED elements by the LED element characteristic data arranging unit 45 and stored in the LED element characteristic data storing unit 46, and calculates the drive current correction data P for each of the plurality of LED elements forming the LED array 31 on the basis of the characteristic data arranged every LED element in accordance with a predetermined arithmetic expression. The drive current correction data P calculated by the drive current correction data computing unit 39 is outputted to the image data correction computing unit 44.

In such a manner, the drive current correction data P for each of the LED elements can be computed efficiently by the drive current correction data computing unit 39, and image data can be corrected by the image data correction computing unit 44 at high speed.

The procedure of light emission control of the LED elements in the fourth embodiment will be described with reference to FIG. 14. First, in a manner similar to the first embodiment, in order to set the first line as an object out of the total number N of lines, n is set to 1 (n=1) (step S201). Next, characteristic data of each of the LED elements is read out from the characteristic data storing unit 35 (step S202) and is arranged for each of the LED elements in the LED element characteristic data arranging unit 45 (step S203). Then, the LED element characteristic data storing unit 46 reads out the arranged characteristic data, and stores the read arranged characteristic data (step S204). In the drive current correction data computing unit 39, the arranged characteristic data stored in the LED element characteristic data storing unit 46 is read out (step S205), and the drive current correction data P for each of the LED elements is computed (step S206). Then, the calculated drive current correction data P is outputted to the image data correction computing unit 44 (step S207). After that, a procedure of steps S208 to S212 corresponding to steps S5 to S9 (see FIG. 8) in the first embodiment is performed.

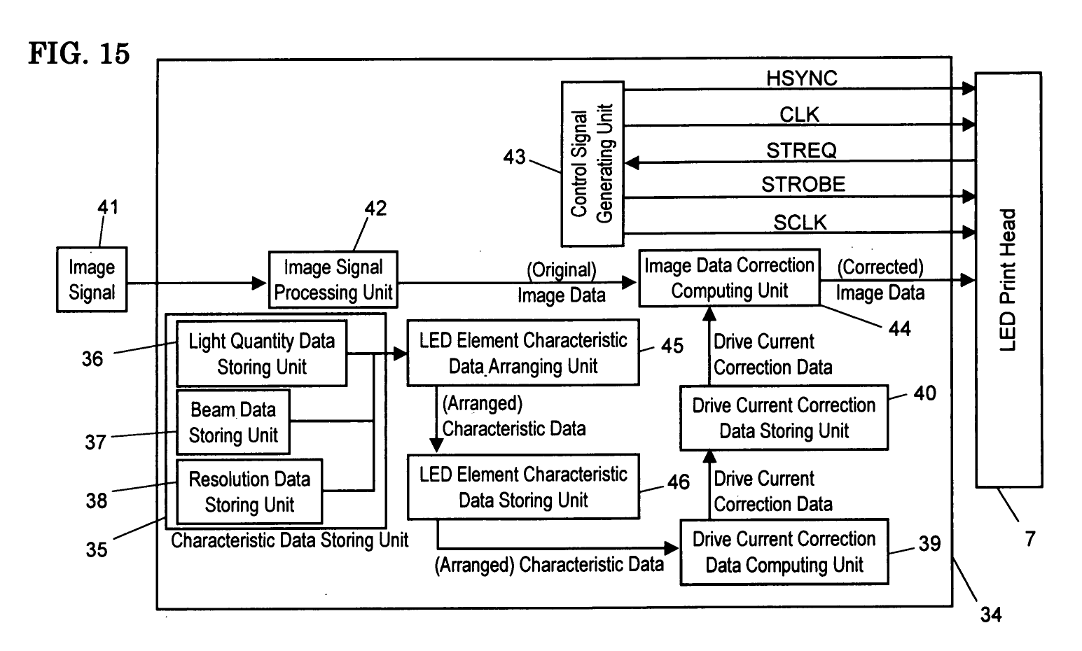

In the fourth embodiment, in a manner similar to the first embodiment, the drive current correction data P is calculated by the drive current correction data computing unit 39 and, after that, is outputted directly to the image data correction computing unit 44. In contrast, in a fifth embodiment of the present invention, in a manner similar to the first and second embodiments, as shown in FIG. 15, the drive current correction data storing unit 40 for storing the drive current correction data P calculated by the drive current correction data computing unit 39 is separately provided. The drive current correction data storing unit 40 is connected to the drive current correction data computing unit 39 and the image data correction computing unit 44.

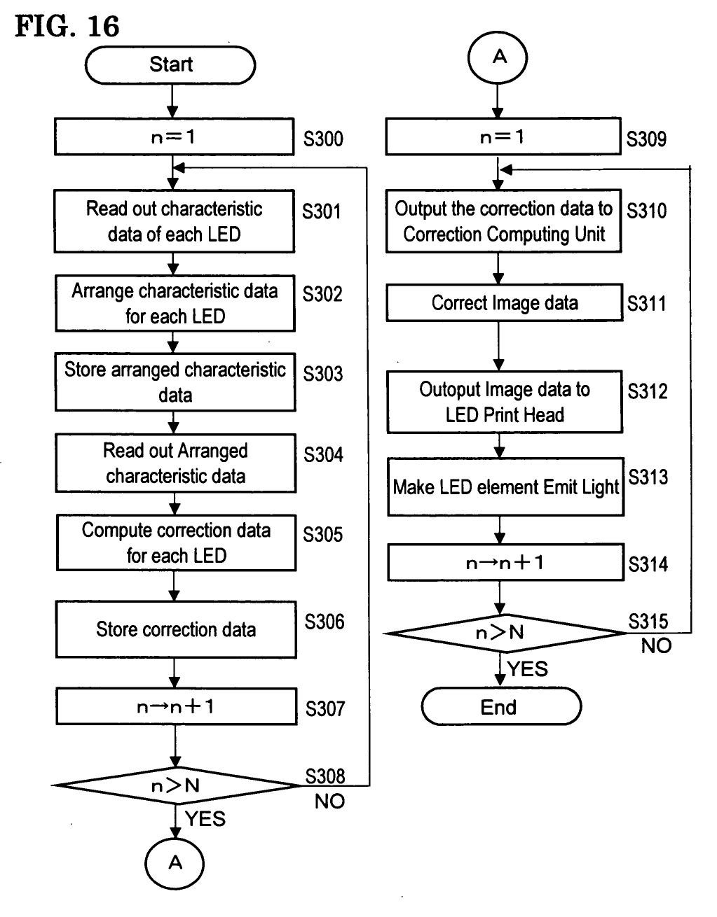

The procedure of light emission control of the LED elements in the fifth embodiment will be described with reference to FIG. 16. First, in a manner similar to the second embodiment, in order to set the first line as an object out of the total number N of lines, n is set to 1 (n=1) (step S300). Next, characteristic data of each of the LED elements is read out from the characteristic data storing unit 35 (step S301), and is arranged for each of the LED elements in the LED element characteristic data arranging unit 45 (step S302). Next, the LED element characteristic data storing unit 46 reads out the arranged characteristic data, and stores the read arranged characteristic data (step S303). Next, in the drive current correction data computing unit 39, the arranged characteristic data stored in the LED element characteristic data storing unit 46 is read out (step S304), and the drive current correction data P for each of the LED elements is computed by the drive current correction data computing unit 39 (step S305). Next, the calculated drive current correction data P is stored in the drive current correction data storing unit 40 (step S306). After that, a procedure of steps S307 to S315 corresponding to steps S104 to S112 (see FIG. 10) in the second embodiment is performed.

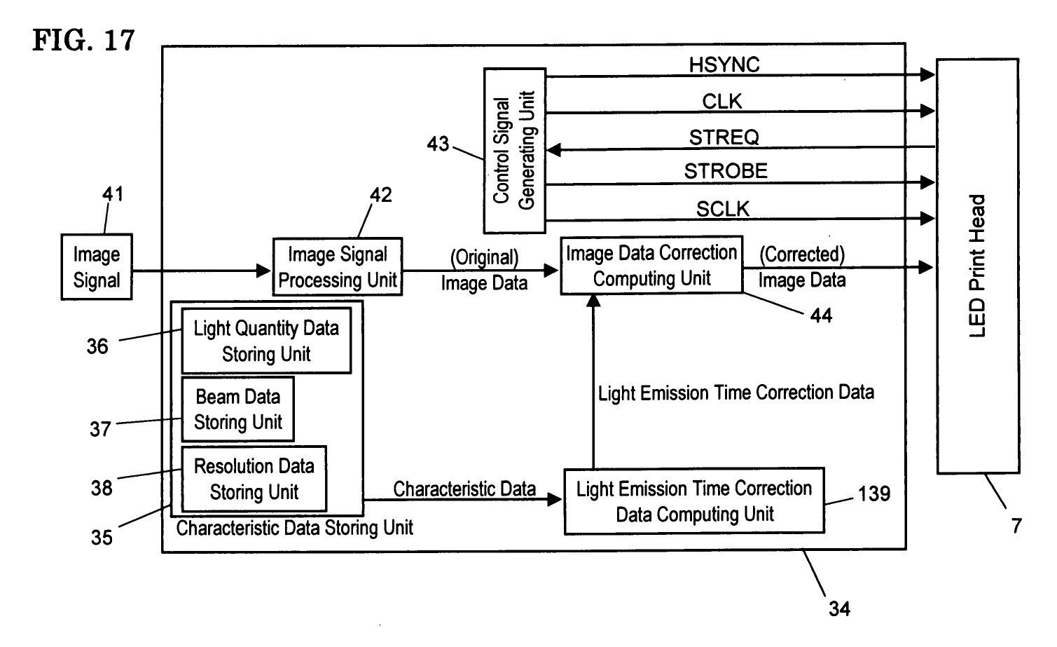

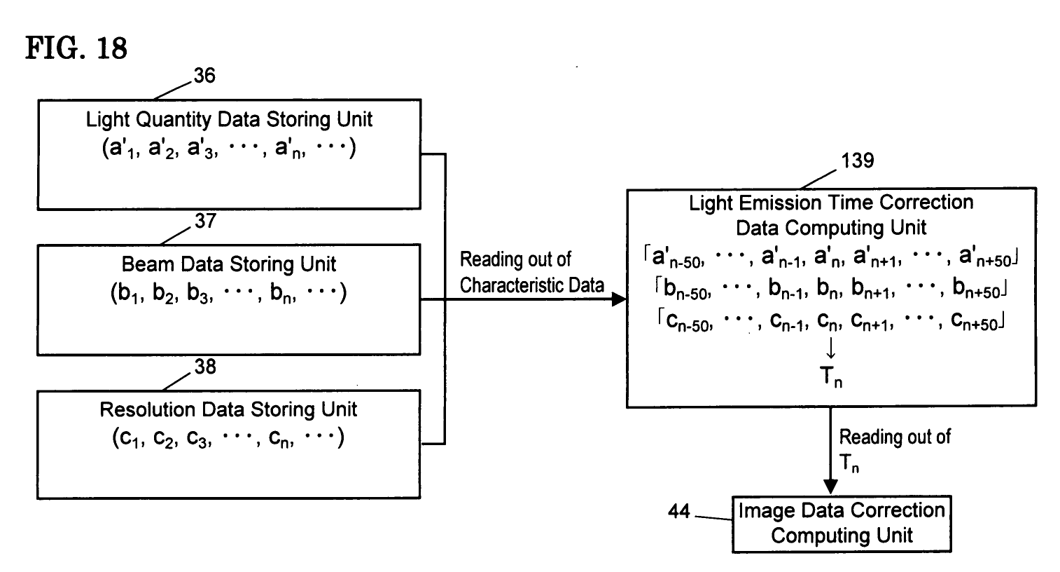

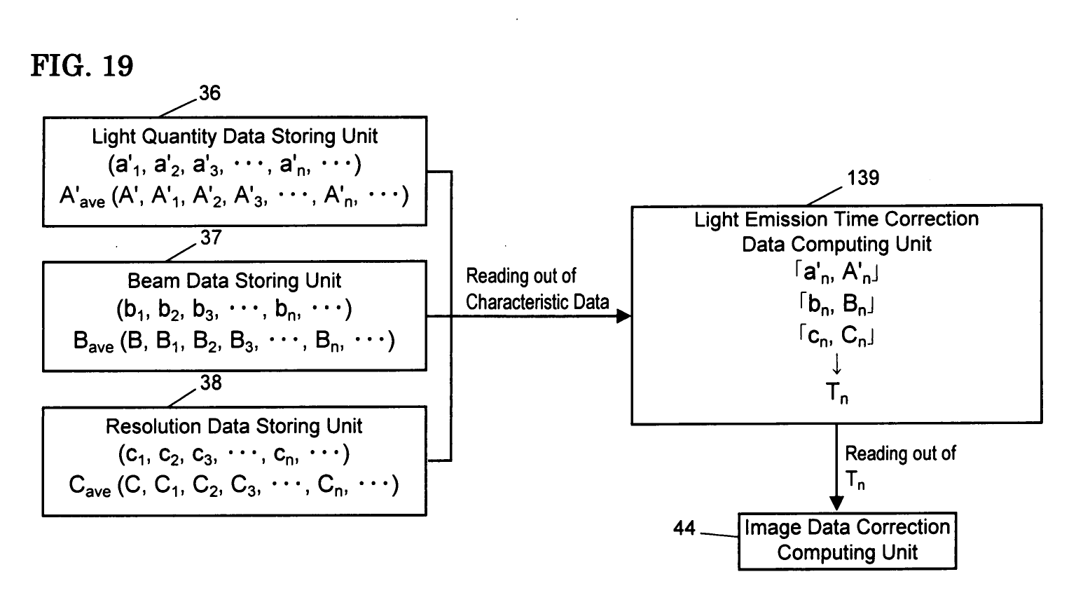

A sixth embodiment of the present invention will now be described with reference to FIGS. 17 to 19. FIG. 17 is a block diagram showing the configuration of an LED array control unit in an image forming apparatus according to the sixth embodiment. FIGS. 18 and 19 are block diagrams each showing a process of computing drive current correction data in the image forming apparatus. Since the general configuration of the image forming apparatus, the schematic configuration of the LED array print head, the configuration of the drive circuit of the LED print head, and the functions thereof are similar to those in the first embodiment, their detailed description will not be repeated herein.

The sixth embodiment has a feature in that the drive current correction data computing unit 39 in the first embodiment is replaced with a light emission time correction data computing unit 139. Specifically, as shown in FIG. 17, the light emission time correction data computing unit 139 is connected to the characteristic data storing unit 35. The light emission time correction data computing unit 139 reads out characteristic data stored in the light quantity data storing unit 36, beam data storing unit 37 and resolution data storing unit 38 which are provided in the characteristic data storing unit 35, and calculates light emission time correction data T for each of the plurality of LED elements forming the LED array 31 on the basis of the characteristic data in accordance with a predetermined arithmetic expression. The light emission time correction data T calculated by the light emission time correction data computing unit 139 is outputted to the image data correction computing unit 44.

The light emission time correction data T is, as will be described later, data used at the time of changing the intensity of light exposure of each of the LED elements forming the LED array 31 by changing the light emission time of each of the LED elements. For example, in the case of correcting light emission time of the dot 1 (the first LED element), light emission time correction data Tₙ is used. In the case of correcting light emission time of the dot n (the n-th LED element), light emission time correction data Tₙ is used.

Herein, similarly to the drive current correction data computing unit 39 described in the first embodiment, the light emission time correction data computing unit 139 in the sixth embodiment calculates light emission time correction data using not only characteristic data of a predetermined LED element to be corrected but also characteristic data of a plurality of LED elements in a predetermined range including the predetermined LED element to be corrected. However, it is also possible to modify the sixth embodiment so as to calculate light emission time correction data using only the characteristic data of the predetermined LED to be corrected.

In the sixth embodiment, as shown in FIG. 18, for example, in the case of calculating the light emission time correction data Tₙ for correcting the light emission time of the dot n (the n-th LED element) and using characteristic data of 100 LED elements arranged before and after the dot n (specifically, 50 LED elements from the dot n−1 to the dot n−50 and 50 LED elements from the dot n+1 to the dot n+50), the light emission time correction data computing unit 139 reads out the characteristic data regarding the dot n stored in the light quantity data storing unit 36, beam data storing unit 37 and resolution data storing unit 38 (light quantity data a′ₙ, beam data bₙ and resolution data cₙ), characteristic data regarding from the dot n−1 to the dot n−50 (light quantity data a′ₙ₋₁ to a′ₙ₋₅₀, beam data bₙ₋₁ to bₙ₋₅₀ and resolution data cₙ₋₁ to cₙ₋₅₀), and characteristic data regarding the dot n+1 to the dot n+50 (light quantity data a′ₙ₊₁ to a′ₙ₊₅₀, beam data bₙ₊₁ to bₙ₊₅₀ and resolution data cₙ₊₁ to cₙ₊₅₀) out of the plurality of characteristic data stored in the characteristic data storing unit 35. Subsequently, in accordance with a predetermined arithmetic expression, the light emission time correction data computing unit 139 calculates the light emission time correction data Tₙ for the dot n on the basis of the read characteristic data of the predetermined LED element (that is, dot n) and the read characteristic data of each of the plurality of LED elements (specifically, the 50 LED elements from the dot n−1 to the dot n−50 and the 50 LED elements from the dot n+1 to the dot n+50) in the predetermined range including the predetermined LED element to be corrected. Then, as shown in FIG. 18, the light emission time correction data Tₙ calculated by the light emission time correction data computing unit 139 is read out by the image data correction computing unit 44.

As described above, at the time of computing the light emission time correction data T in the light emission time correction data computing unit 139, by using not only the characteristic data of the predetermined LED element to be corrected but also the characteristic data of the plurality of LED elements in the predetermined range including the predetermined LED element to be corrected, high-precision light emission time correction data T can be obtained. As a result, image data can be corrected with high precision.

In a manner similar to the drive current correction data computing unit 39 described in the first embodiment, at the time of computing the light emission time correction data T by the light emission time correction data computing unit 139, light emission time correction data may be calculated using not only the characteristic data of the predetermined LED element to be corrected but also an average value of characteristic data of all of the LED elements forming the LED array 31 or an average value of characteristic data of a plurality of LED elements in a predetermined range including the predetermined LED element to be corrected.

In this case, as shown in FIG. 19, in the light quantity data storing unit 36, Aₐᵥₑ is prestored, which is constructed by an average value A of light quantity data of all of LED elements forming the LED array 31 and average values (for example, A₁ for the dot 1 and Aₙ for the dot n) of the light quantity data of a plurality of LED elements in a predetermined range including the predetermined LED element to be corrected. In the beam data storing unit 37, Bₐᵥₑ is prestored, which is constructed by an average value B of beam data of all of LED elements forming the LED array 31 and average values (for example, B, for the dot 1 and Bₙ for the dot n) of the beam data of a plurality of LED elements in a predetermined range including the predetermined LED element to be corrected. In the resolution data storing unit 38, Cₐᵥₑ is prestored, which is constructed by an average value C of resolution data of all of LED elements forming the LED array 31 and average values (for example, C₁ for the dot 1 and Cₙ for the dot n) of the resolution data of a plurality of LED elements in a predetermined range including the predetermined LED element to be corrected.

Herein, for example, in the case of using the dynamic driving method and calculating the light emission time correction data Tₙ for correcting the light emission time of the dot n, as shown in FIG. 19, the light emission time correction data computing unit 139 reads out characteristic data (light quantity data a′ₙ, beam data bₙ and resolution data cₙ) regarding the dot n out of the characteristic data stored in the light quantity data storing unit 36, beam data storing unit 37 and resolution data storing unit 38, and average values (Aₙ, Bₙ and Cₙ) of the characteristic data of a plurality of LED elements in a predetermined range including the dot n to be corrected. Then, in accordance with a predetermined arithmetic expression, on the basis of the read characteristic data of the predetermined LED element (that is, the dot n) and the read average values of the characteristic data of the plurality of LED elements in the predetermined range including the predetermined LED element to be corrected, the light emission time correction data computing unit 139 calculates the light emission time correction data Tₙ for the dot n. As shown in FIG. 19, the light emission time correction data Tₙ calculated by the light emission time correction data computing unit 139 is then read out by the image data correction computing unit 44.

On the other hand, in the case of using the static driving method and calculating the light emission time correction data Tₙ for correcting the light emission time of the dot n, the light emission time correction data computing unit 139 reads out characteristic data (light quantity data a′ₙ, beam data bₙ and resolution data cₙ) regarding the dot n out of the characteristic data stored in the light quantity data storing unit 36, beam data storing unit 37 and resolution data storing unit 38, and average values (A, B and C) of the characteristic data of all of LED elements forming the LED array 31. Then, in accordance to a predetermined arithmetic expression, on the basis of the read characteristic data of the predetermined LED element (that is, the dot n) and the read average values of the characteristic data of all of the LED elements forming the LED array 31, the light emission time correction data computing unit 139 calculates the light emission time correction data Tₙ for the dot n. As shown in FIG. 19, the light emission time correction data Tₙ calculated by the light emission time correction data computing unit 139 is read out by the image data correction computing unit 44.

As described above, at the time of computing the light emission time correction data T in the light emission time correction data computing unit 139, by using not only the characteristic data of a predetermined LED element to be corrected but also an average value of characteristic data of all of LED elements forming the LED array 31 or an average value of the characteristic data of a plurality of LED elements in a predetermined range including the predetermined LED element to be corrected, high-precision light emission time correction data T adapted to the drive method can be obtained and, as a result, the image data can be corrected with high precision.

The image data correction computing unit 44 corrects the image data outputted from the image signal processing unit 42 as described above. In the sixth embodiment, the light emission time of the image data outputted from the image signal processing unit 42 is corrected using the light emission time correction data T outputted from the light emission time correction data computing unit 139. Specifically, the image data correction computing unit 44 corrects m-bit digital data indicative of the light emission time of each of the LED elements forming the LED array 31 out of the image data outputted from the image signal processing unit 42 in accordance with the light emission time correction data T outputted from the light emission time correction data computing unit 139. The corrected image data is outputted to the LED print head 7 as shown in FIG. 17.

Subsequently, by the drive circuit 33 of the LED print head 7 described with reference to FIG. 5, drive current based on image data stored in the storing unit 52 is passed to each of the LED elements forming the LED array 31 only by light emission time based on the light emission time correction data T generated using the characteristic data, thereby exposing the photoreceptor 5.

Since the procedure of the light emission control of the LED elements in the sixth embodiment is similar to that in the first embodiment described with reference to FIG. 8, its detailed description will not be repeated herein.

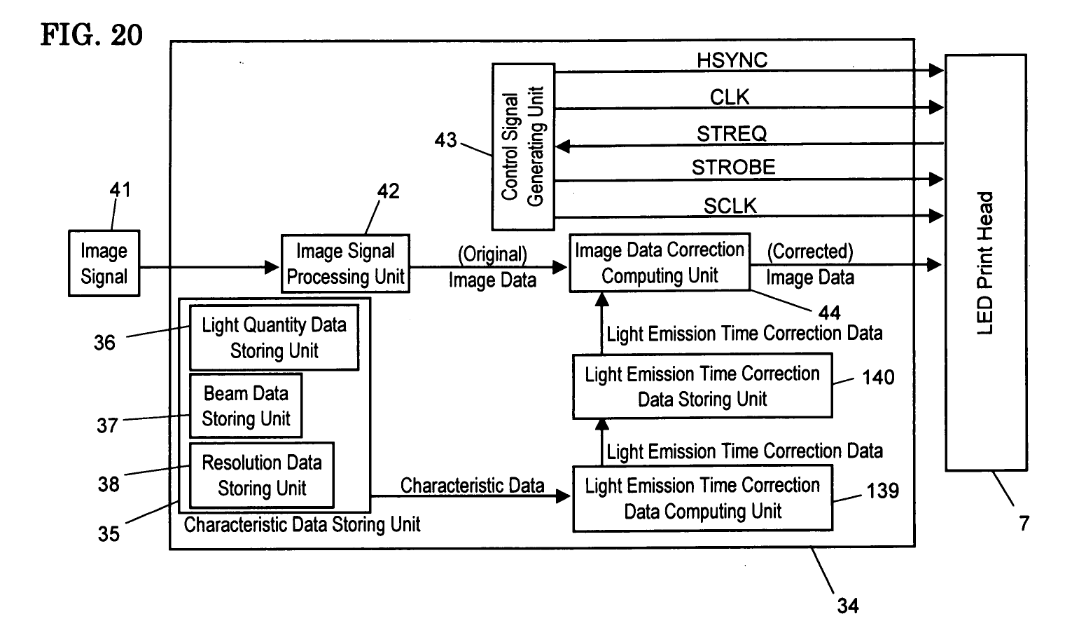

In the sixth embodiment, the light emission time correction data T is calculated by the light emission time correction data computing unit 139 and is outputted directly to the image data correction computing unit 44. In a manner similar to the modification of the first embodiment, that is, like the second embodiment as a modification of the first embodiment, as shown in FIG. 20, it is also possible to separately provide a light emission time correction data storing unit 140 for storing the light emission time correction data T calculated by the light emission time correction data computing unit 139 and connect the light emission time correction data storing unit 140 to the light emission time correction data computing unit 139 and the image data correction computing unit 44. Hereinafter, this configuration will be described as a seventh embodiment.

In the seventh embodiment, as shown in FIG. 20, the light emission time correction data storing unit 140 reads out the light emission time correction data T computed by the light emission time correction data computing unit 139 described with reference to FIGS. 18 and 19 from the light emission time correction data computing unit 139, stores the light emission time correction data T, and outputs the light emission time correction data T to the image data correction computing unit 44. In a manner similar to the drive current correction data storing unit 40 described in the second embodiment, in order to address a change in the light emission time correction data T based on a characteristic change of each of the LED elements, for example, a rewritable PROM (for example, an EPROM which erases data with ultraviolet light or an EEPROM which electrically erases data) may be employed as the light emission time correction data storing unit 140. The functions of the other parts are similar to those of the above-mentioned sixth embodiment, so that their description will not be repeated herein.

With such a configuration, even in the case where it takes long time to compute the light emission time correction data T, since the pre-computed light emission time correction data T is stored in the light emission time correction data storing unit 140, the light emission time correction data T can be promptly read out by the image data correction computing unit 44. As a result, image data correction by the image data correction computing unit 44 can be performed at higher speed.

The procedure of the light emission control of the LED element in the seventh embodiment is similar to that in the second embodiment described with reference to FIG. 10, so that its detailed description will not be repeated herein.

An eighth embodiment of the present invention will now be described. The eighth embodiment has a feature in that an arithmetic expression suitable for calculating the light emission time correction data T for each of the LED elements is embodied in the light emission time correction data computing unit 139 in the sixth and seventh embodiments.

The light emission time correction data T is calculated by, for example, the following arithmetic expression (3) in the light emission time correction data computing unit 139 to stabilize calculation precision.

Tₙ=a′ₙ+α·(bₙ−Bₐᵥₑ)/Bₐᵥₑ+·(cₙ−Cₐᵥₑ)/Cₐᵥₑ Equation (3)

Tₙ denotes light emission time correction data of the n-th LED element. a′ₙ denotes light emission time reference data of the n-th LED element for making the light quantities for the LED elements substantially constant and is stored in the light quantity data storing unit 36. bₙ denotes data regarding a beam of the n-th LED element (for example, the beam diameter and the beam area) and is stored in the beam data storing unit 37. cₙ denotes resolution data of the n-th LED element and is stored in the resolution data storing unit 38. α denotes an arithmetic coefficient regarding a beam, and P denotes an arithmetic coefficient regarding resolution. Bₐᵥₑ is an average value of data regarding beams of all of the LED elements or an average value of data regarding beams of a plurality of LED elements in a predetermined range including the n-th LED element (for example, 50 LED elements before and 50 LED elements after the n-th LED element) and may be calculated at the time of computation by the light emission time correction data computing unit 139 or prestored in the beam data storing unit 37. Cₐᵥₑ denotes, similarly to Bₐᵥₑ, an average value of resolution data of all of LED elements or an average value of resolution data of a plurality of LED elements in a predetermined range including the n-th LED element, and may be calculated at the time of computation by the light emission time correction data computing unit 139 or prestored in the resolution data storing unit 38.

Alternately, the light emission time correction data T may be calculated by the following arithmetic expression (4).

Tₙ=a′ₙ+α·(bₙ−Bₐᵥₑ)/Bₐᵥₑ Equation (4)

Tₙa′ₙ, bₙ, α and Bₐᵥₑ are similar to the above. Equation (4) is useful in the case where it is unnecessary to consider resolution data of an LED element. In this case, the resolution data storing unit 38 becomes unnecessary. Therefore, there is an advantage that the configuration can be simplified as compared with the case of Equation (3) since it is unnecessary to provide the resolution data storing unit 39.

Since the functions of the other parts are similar to those of the sixth and seventh embodiments, their detailed description will not be repeated herein.

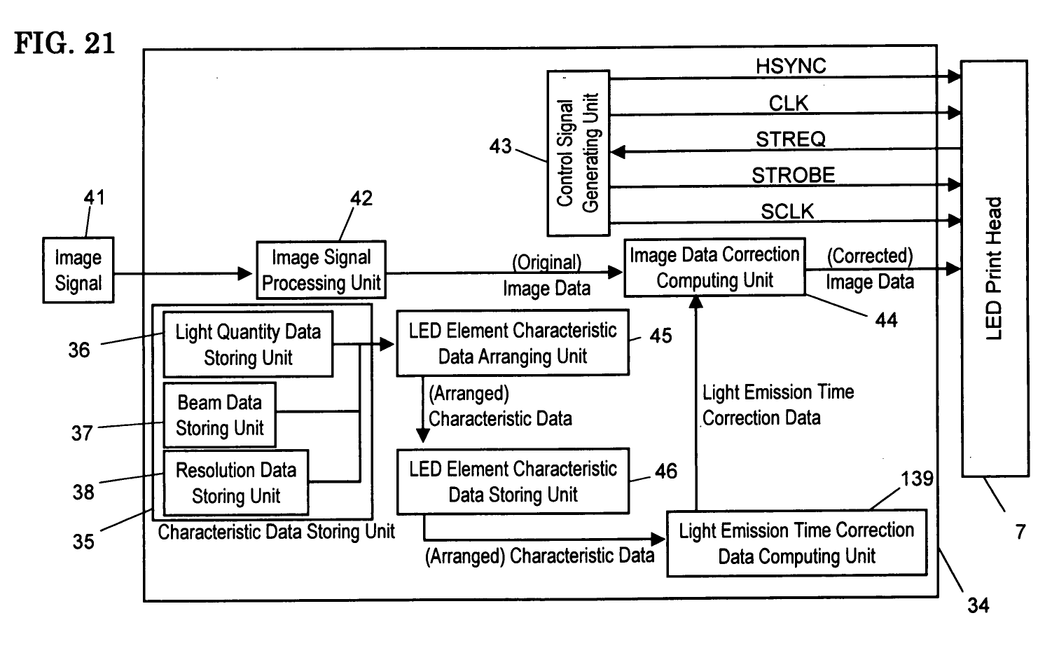

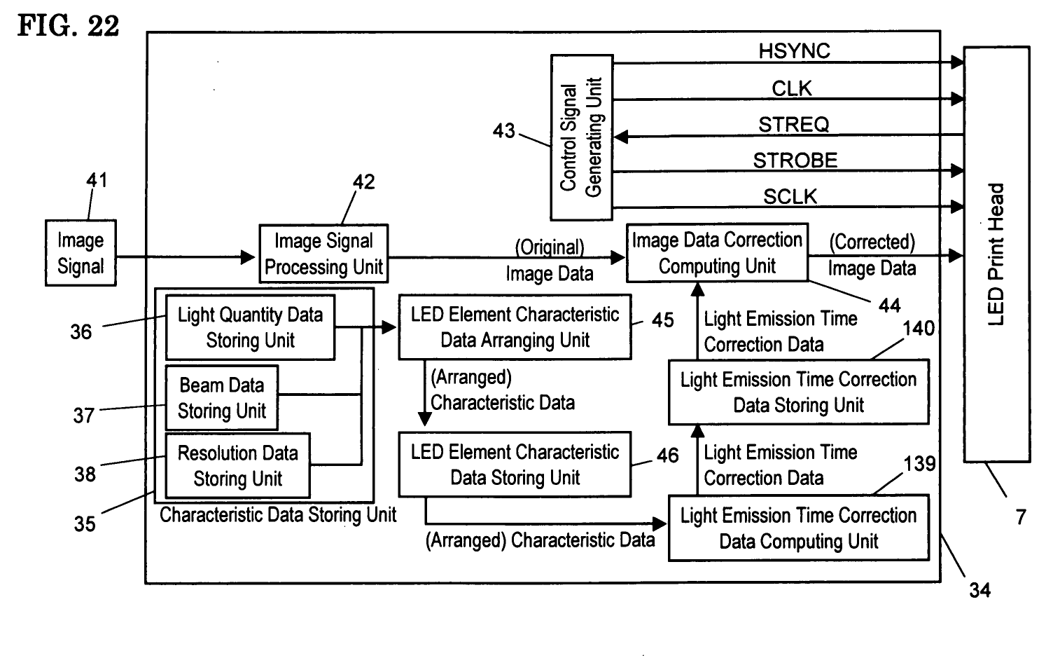

Ninth and tenth embodiments of the present invention will now be described with reference to FIGS. 21 and 22. FIG. 21 is a block diagram showing the configuration of an LED array control unit in the image forming apparatus according to the ninth embodiment. FIG. 22 is a block diagram showing the configuration of an LED array control unit in an image forming apparatus according to the tenth embodiment. The same reference numerals are given to components which are the same as those of FIGS. 1 to 5 and FIGS. 9, 11, 15, 17 and 20 and their description will not be repeated herein.

The ninth embodiment has a feature in that, as a modification of the sixth embodiment, the drive current correction data computing unit 39 in the fourth embodiment is replaced with the light emission time correction data computing unit 139. Similarly, the tenth embodiment has a feature in that, as a modification of the seventh embodiment, the drive current correction data computing unit 39 in the fifth embodiment is replaced with the light emission time correction data computing unit 139. Specifically, as shown in FIGS. 21 and 22, in the ninth and tenth embodiments, the LED element characteristic data arranging unit 45 which functions in a manner similar to that described in the fourth and fifth embodiments is connected to the characteristic data storing unit 35. The LED element characteristic data arranging unit 45 is connected to the light emission time correction data computing unit 139 via the LED element characteristic data storing unit 46 which functions in a manner similar to that described in the fourth and fifth embodiments.

The light emission time correction data computing unit 139 reads out characteristic data stored in the LED element characteristic data storing unit 46 and arranged for each of the LED elements by the LED element characteristic data arranging unit 45, and calculates the light emission time correction data T for each of the plurality of LED elements forming the LED array 31 on the basis of the characteristic data arranged for each of the LED elements in accordance with a predetermined arithmetic expression.

Consequently, the light emission time correction data T for each of the LED elements can be efficiently calculated by the light emission time correction data computing unit 139, and image data can be corrected by the image data correction computing unit 44 at high speed.

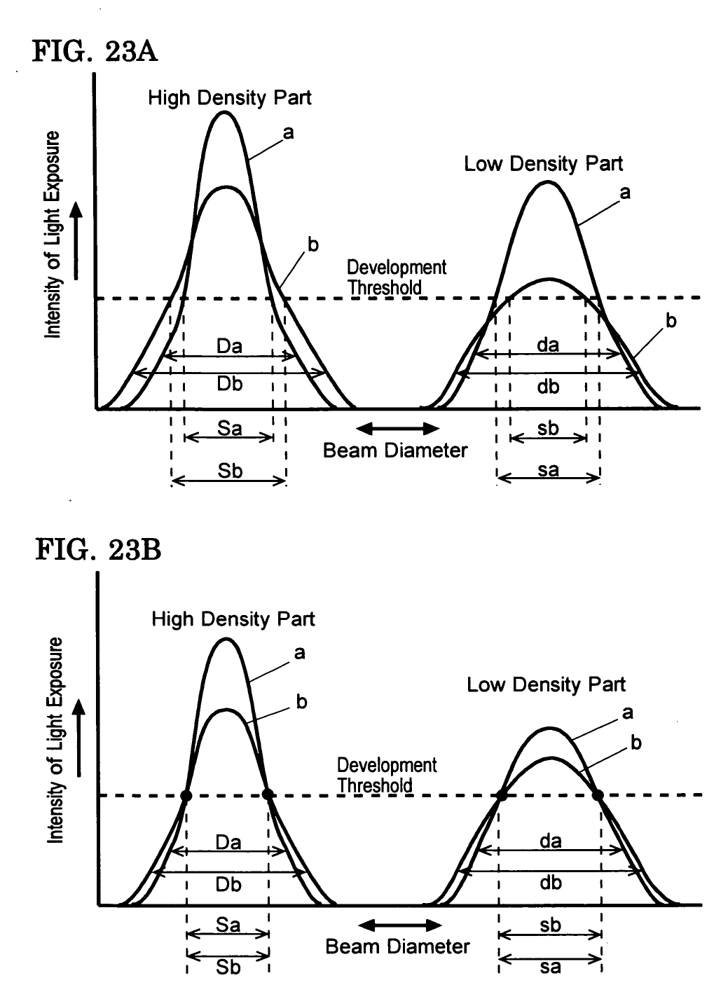

FIGS. 23A and 23B show the relationship between the intensity of light exposure of an LED element and a beam diameter at a development threshold. FIG. 23A shows the relationship between the intensity of light exposure of an LED element and the beam diameter at a development threshold before image data is corrected. FIG. 23B shows the relationship between the intensity of light exposure of an LED element and the beam diameter at the development threshold after the image data is corrected. As shown in FIG. 23A, a light emission quantity (peak area in the figure) of an LED element “a” and that of an LED element “b” are about the same in both of the cases of a high density part and a low density part. However, the beam diameters of the LED elements “a” and “b” are different from each other (the beam diameter is generally specified within the range of 13.5% of the peak light quantity). Specifically, in both of the cases of the high density part and the low density part, the beam diameter of the light emission element “b” is larger than that of the light emission element “a” (D_{b}>Dₐ, d_{b}>dₐ).

However, as shown in FIG. 23A, in the high density part, a dot diameter S_{b} at the development threshold of the LED element “b” is larger than a dot diameter Sₐ of the LED element “a”. In the low density part, in contrast to the case of the high density part, the dot diameter sₐ at the development threshold of the LED element “a” is larger than the dot diameter s_{b} of the LED element “b”. In other words, the relationship between the dot diameter at the development threshold of the LED element “a” and that of the element “b” does not depend on the size relationship of the beam diameters but depends on display density of an LED element. Therefore, in this situation, in the high density part, a latent image dot of the LED element “b” having the dot diameter larger at the development threshold is larger. In the low density part, a latent mage dot of the LED element “a” having the larger dot diameter at the development threshold is larger. On an image, the LED element having the larger dot diameter is expressed with higher density.

In order to address the problem, the beam diameters in each of the display density parts of the LED elements “a” and “b” are pre-stored as characteristic data. Correction data for drive current (or light emission time) is generated using the characteristic data of the beam diameters to thereby solve the difference between the display densities of the LED elements “a” and “b” in the display density parts.

Specifically, as shown in FIG. 23B, in the high density part, drive current correction data (or light emission time correction data) is generated using the characteristic data regarding the beam diameter so that the drive current of the LED element “b” having the larger beam diameter (larger dot diameter) is decreased (or the light emission time is shortened) and the drive current of the LED element “a” having the smaller beam diameter (or smaller dot diameter) is increased (or the light emission time is increased). In the low density part, drive current correction data (or light emission time correction data) is generated using the characteristic data regarding the beam diameter so that the drive current of the LED element “b” having the larger beam diameter (smaller dot diameter) is increased (or the light emission time is increased) and the drive current of the LED element “a” having the smaller beam diameter (or lager dot diameter) is decreased (or the light emission time is shortened). By the above method, the dot diameter of the LED element “a” and that of the LED element “b” at the development threshold in each of the display density parts become the same. Thus, in both of the display density parts, the difference between the display density of the LED element “a” and that of the LED element “b” can be eliminated.

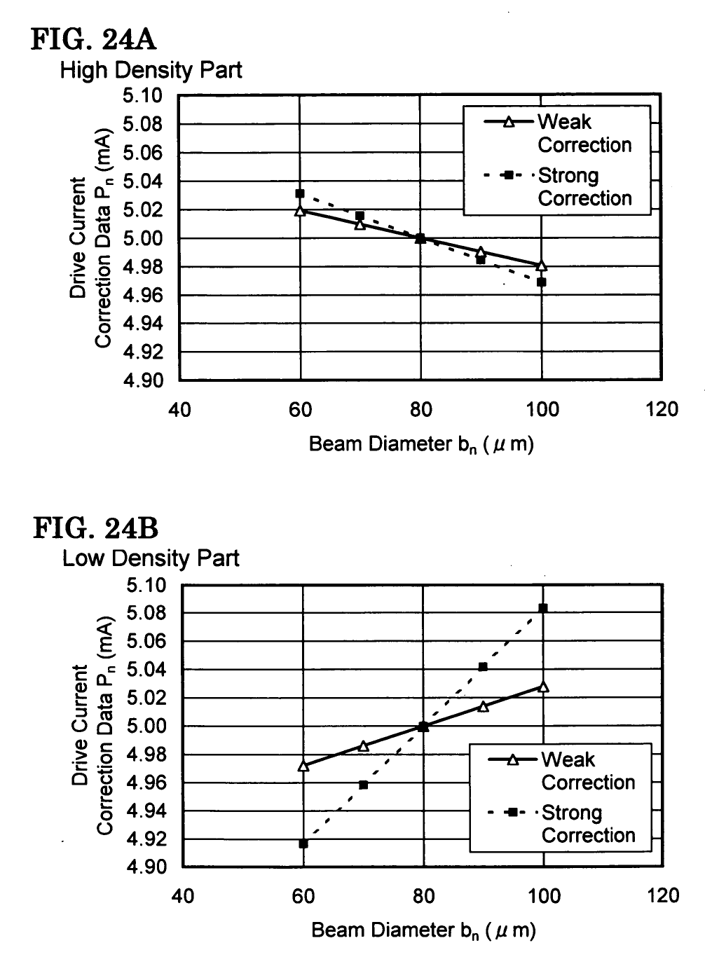

The drive current correction data in the first to fifth embodiments is generated in accordance with a predetermined arithmetic expression. An example will be described with reference to FIGS. 24A and 24B. The example is used for forming an image of multi-value gradations from 0 to 15 gradations. As an arithmetic expression, Equation (2) described in the third embodiment is applied. As the data bₙ regarding a beam, the beam diameter of an LED element is employed. An arithmetic coefficient α which is proper at two gradations in a high density part (15th gradation) and a low density part (fifth gradation) is set. The arithmetic coefficients α at other gradations are computed by interpolation and set.

In the high density part, as shown in FIG. 24A, as the beam diameter bₙ increases, the drive current correction data Pₙ decreases. In the other low density part, as shown in FIG. 24B, as the beam diameter bₙ increases, the drive current correction data Pₙ increases. Consequently, the mode shown in FIG. 23B is realized. FIGS. 24A and 24B show the case where the drive current reference data aₙ is 5 mA (milliampere), and the average value Bₐᵥₑ of the beam diameter bₙ is 80 μm. In the high density part, the arithmetic coefficient α is set to −0.077 when weak correction (see the solid line in FIG. 24A) has to be selected, and is set to −0.125 when strong correction (see the broken line in FIG. 24A) has to be selected. In the low density part, the arithmetic coefficient α is set to 0.111 when weak correction (see the solid line in FIG. 24B) has to be selected, and is set to 0.333 when strong correction (see the broken line in FIG. 24B) has to be selected.

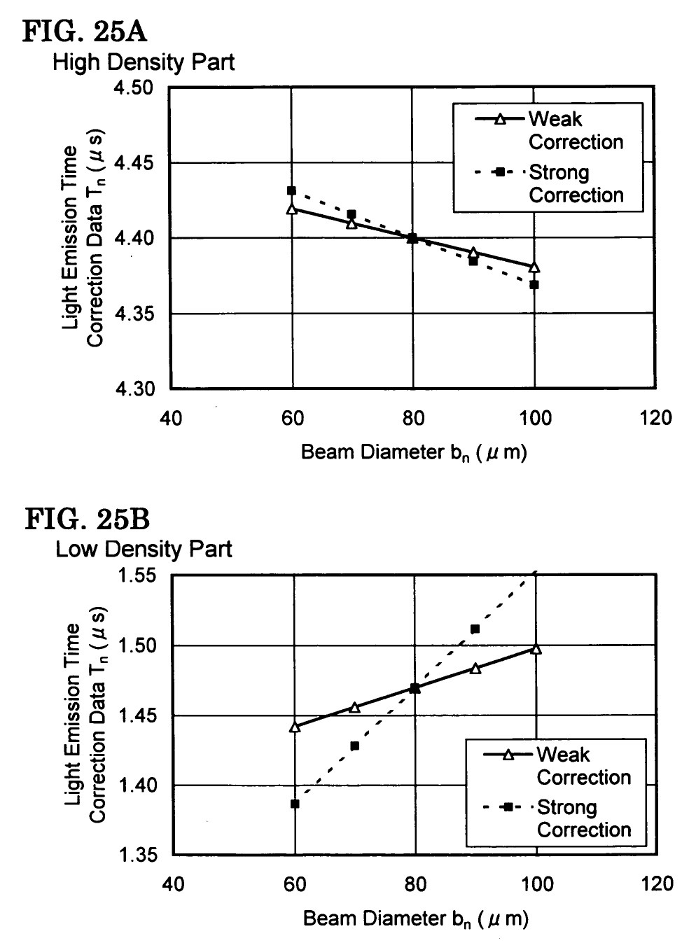

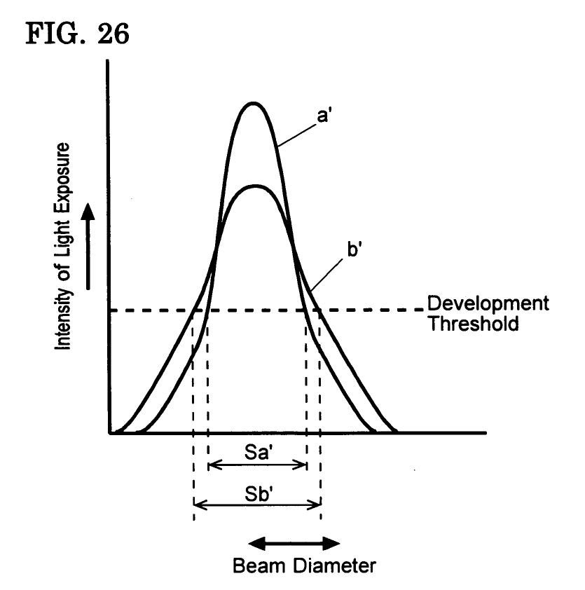

The light emission time correction data in the sixth to tenth embodiments is generated in accordance with a predetermined arithmetic expression. An example will be described with reference to FIGS. 25A and 25B. The example is used for forming an image of multi-value gradations from 0 to 15 gradations. As an arithmetic expression, Equation (4) described in the eighth embodiment is applied. As the data bₙ regarding a beam, the beam diameter of an LED element is employed. An arithmetic coefficient α which is proper at two gradations in a high density part (15th gradation) and a low density part (fifth gradation) is set. The arithmetic coefficients α at other gradations are computed by interpolation and set.

In the high density part, as shown in FIG. 25A, as the beam diameter bₙ increases, the light emission time correction data Tₙ decreases. In the other low density part, as shown in FIG. 25B, as the beam diameter bₙ increases, the light emission time correction data Tₙ increases. Consequently, the mode shown in FIG. 23B is realized. FIGS. 25A and 25B show the case where the average value Bₐᵥₑ of the beam diameter bₙ is 80 μm. The light emission time reference data a′ₙ is 4.40 μsec. in the high density part and is 1.47 μsec. in the low density part. In the high density part, the arithmetic coefficient α is set to −0.077 when weak correction (see the solid line in FIG. 25A) has to be selected, and is set to −0.125 when strong correction (see the broken line in FIG. 25A) has to be selected. In the low density part, the arithmetic coefficient α is set to 0.111 when weak correction (see the solid line in FIG. 25B) has to be selected, and is set to 0.333 when strong correction (see the broken line in FIG. 25B) has to be selected.

In the examples, the arithmetic coefficients are set at representative two gradations and arithmetic coefficients calculated by interpolation are set at the other gradations. However, the present invention is not limited thereto. For example, it is also possible to set a proper arithmetic coefficient at one gradation in which density non-uniformity of an image is the most conspicuous and to apply the arithmetic coefficient to all of the gradations. Alternately, proper arithmetic coefficients may be set at all of gradations.

FIGS. 23 to 25 show the case of generating the drive current correction data using the beam diameter as characteristic data of an LED element. Alternately, as described above, the drive current correction data (or light emission time correction data) can be also generated using, as characteristic data, each or a combination of the light quantity data of each of the LED elements, data regarding the beam area, and data indicative of resolution such as MTF data. Obviously, the drive current correction data (or light emission time correction data) can be also generated by combining, with the above-mentioned characteristic data, data of a plurality of LED elements in a predetermined range including an LED element to be corrected, and an average value of various characteristic data of all of LED elements forming the LED array 31 or an average value of various characteristic data of a plurality of LED elements in a predetermined range including the LED element to be corrected.

As described above, in the above-mentioned embodiments, the characteristic data storing unit 35 is provided for storing a plurality of pieces of characteristic data which are preliminarily measured and are causes of density non-uniformity in an image, with respect to a plurality of LED elements forming the LED array 31. The drive current correction data computing unit 39 (or the light emission time correction data computing unit 139) is also provided for reading out the characteristic data stored in the characteristic data storing unit 35 and calculating the drive current correction data P (or the light emission time correction data T) of each of the LED elements forming the LED array 31. The drive current based on the drive current correction data P flows in each of the LED elements, and the drive current based on image data flows in each of the LED elements only by light emission time based on the light emission time correction data T. Consequently, differences in the display density among the LED elements can be reduced with high precision and density non-uniformity of an image can be suppressed. As a result, occurrence of a vertical stripe in an image can be reduced efficiently.

Each of the above-mentioned embodiments employs a configuration that a rewritable PROM can be used as the characteristic storing unit 35. Consequently, even in the case where a change occurs in the characteristics of LED elements, the characteristic data of each of the LED elements can be smoothly rewritten. Therefore, at the time of computing the drive current correction data P (or the light emission time correction data T), drive current correction data (or light emission time correction data) for each of the LED elements can be computed with high precision. As a result, image data can be corrected with high precision.

Although the photoreceptor has a drum shape in each of the above-mentioned embodiments, the shape is not limited to the drum shape. For example, a belt-shaped photoreceptor may be used.

In the above-mentioned embodiments, a color image is obtained from toner images of black, yellow, cyan and magenta. The present invention can be also applied to a color image forming apparatus using two or more different colors of toners.

From the above description, it is clear that the invention can be variously varied and modified. It is to be understood that the invention is carried out within the scope of claims without being limited to the concrete descriptions.

What is claimed is:

1. An image forming apparatus comprising:
an LED print head having an LED array formed by a plurality of LED elements which are controlled to emit light in accordance with image data and a drive circuit for driving the plurality of LED elements; and
an LED array controller for driving and controlling the LED print head, wherein the LED array controller includes:
a characteristic data memory for storing a plurality of pieces of characteristic data regarding each of the plurality of LED elements; and
a drive current correction data calculator for reading out the characteristic data from the characteristic data memory and calculating drive current correction data for each of the plurality of LED elements on a basis of the characteristic data.

2. An image forming apparatus according to claim 1, wherein the LED array controller further includes a drive current correction data memory for reading out the drive current correction data from the drive current correction data calculator and storing the drive current correction data.

3. An image forming apparatus according to claim 1, wherein in the characteristic data memory, light quantity data regarding each of the plurality of LED elements is stored as the characteristic data.

4. An image forming apparatus according to claim 1, wherein
in the characteristic data memory, data regarding a beam emitted from each of the plurality of LED elements is stored as the characteristic data.

5. An image forming apparatus according to claim 1, wherein
in the characteristic data memory, resolution data regarding each of the plurality of LED elements is stored as the characteristic data.

6. An image forming apparatus comprising:
an LED print head having an LED array formed by a plurality of LED elements which are controlled to emit light in accordance with image data and a drive circuit for driving the plurality of LED elements; and
an LED array controller for driving and controlling the LED print head, wherein
the LED array controller includes:
a characteristic data memory for storing a plurality of pieces of characteristic data regarding each of the plurality of LED elements; and
a drive current correction data calculator for reading out characteristic data of a predetermined LED element and characteristic data of a plurality of LED elements in a predetermined range including the predetermined LED element out of the plurality of pieces of characteristic data from the characteristic data memory, and calculating drive current correction data for the predetermined LED element on a basis of the characteristic data of the predetermined LED element and the characteristic data regarding each of the plurality of LED elements in the predetermined range.

7. An image forming apparatus comprising:
an LED print head having an LED array formed by a plurality of LED elements which are controlled to emit light in accordance with image data and a drive circuit for driving the plurality of LED elements; and
an LED array controller for driving and controlling the LED print head, wherein
the LED array controller includes:
a characteristic data memory for storing a plurality of pieces of characteristic data regarding each of the plurality of LED elements; and
a drive current correction data calculator for reading out characteristic data of a predetermined LED element and an average value of characteristic data of a plurality of LED elements in a predetermined range including the predetermined LED element out of the plurality of pieces of characteristic data from the characteristic data memory, and calculating drive current correction data for the predetermined LED element on a basis of the characteristic data of the predetermined LED element and the average value of the characteristic data regarding each of the plurality of LED elements in the predetermined range.

8. An image forming apparatus comprising:
an LED print head having an LED array formed by a plurality of LED elements which are controlled to emit light in accordance with image data and a drive circuit for driving the plurality of LED elements; and
an LED array controller for driving and controlling the LED print head, wherein
the LED array controller includes:
a characteristic data memory for storing a plurality of pieces of characteristic data regarding each of the plurality of LED elements; and
a drive current correction data calculator for reading out characteristic data of a predetermined LED element and an average value of characteristic data of all of the plurality of LED elements forming the LED array out of the plurality of pieces of characteristic data from the characteristic data memory, and calculating drive current correction data for the predetermined LED element on a basis of the characteristic data of the predetermined LED element and the average value of the characteristic data of all of the plurality of LED elements constructing the LED array.

9. An image forming apparatus according to claim 1, wherein
the drive current correction data satisfies the following equation:
Pₙ=aₙ+α·(bₙ−Bₐᵥₑ)/Bₐᵥₑ
where Pₙ represents drive current correction data of the n-th LED element,
aₙ represents drive current reference data of the n-th LED element for making the light quantity for each of the LED element substantially equal,
bₙ represents data regarding a beam of the n-th LED element,
Bₐᵥₑ represents an average value of data regarding beams of all of the LED elements or an average value of data regarding beams of a plurality of LED elements in a predetermined range including the n-th LED element, and
α represents an arithmetic coefficient regarding a beam.

10. An image forming apparatus according to claim 1, wherein
the drive current correction data satisfies the following equation:
Pₙ=aₙ+α·(bₙ−Bₐᵥₑ)/Bₐᵥₑ+β·(cₙ−Cₐᵥₑ)/Cₐᵥₑ
where Pₙ represents drive current correction data of the n-th LED element,
aₙ represents drive current reference data of the n-th LED element for making the light quantity for each of the LED element substantially equal,
bₙ represents data regarding a beam of the n-th LED element,
Bₐᵥₑ represents an average value of data regarding beams of all of the LED elements or an average value of data regarding beams of a plurality of LED elements in a predetermined range including the n-th LED element,
α represents an arithmetic coefficient regarding a beam,
cₙ represents resolution data of the n-th LED element,
Cₐᵥₑ represents an average value of resolution data of all of LED elements or an average value of resolution data of a plurality of LED elements in a predetermined range including the n-th LED element, and
β represents an arithmetic coefficient regarding resolution.

11. An image forming apparatus comprising:
an LED print head having an LED array formed by a plurality of LED elements which are controlled to emit light in accordance with image data and a drive circuit for driving the plurality of LED elements; and
an LED array controller for driving and controlling the LED print head, wherein
the LED array controller includes:
a characteristic data memory for storing a plurality of pieces of characteristic data regarding each of the plurality of LED elements;
an LED element characteristic data arranger for reading out the characteristic data from the characteristic data memory and arranging the characteristic data for each of the plurality of LED elements; and
a drive current correction data calculator for calculating drive current correction data for each of the plurality of LED elements on a basis of the characteristic data arranged for each of the plurality of LED elements by the LED element characteristic data arranger.

12. An image forming apparatus according to claim 11, further comprising:
an LED element characteristic data memory for storing characteristic data arranged for each of the LED elements by the LED element characteristic data arranger.

13. An image forming apparatus comprising:
an LED print head having an LED array formed by a plurality of LED elements which are controlled to emit light in accordance with image data and a drive circuit for driving the plurality of LED elements; and
an LED array controller for driving and controlling the LED print head, wherein
the LED array controller includes:
a characteristic data memory for storing a plurality of pieces of characteristic data regarding each of the plurality of LED elements; and
a light emission time correction data calculator for reading out the characteristic data from the characteristic data memory and calculating light emission time correction data for each of the plurality of LED elements on a basis of the characteristic data.

14. An image forming apparatus according to claim 13, wherein
the LED array controller further includes a light emission time correction data memory for reading out the light emission time correction data from the light emission time correction data calculator and storing the light emission time correction data.

15. An image forming apparatus according to claim 13, wherein
in the characteristic data memory, light quantity data regarding each of the plurality of LED elements is stored as the characteristic data.

16. An image forming apparatus according to claim 13, wherein
in the characteristic data memory, data regarding a beam emitted from each of the plurality of LED elements is stored as the characteristic data.

17. An image forming apparatus according to claim 13, wherein
in the characteristic data memory, resolution data regarding each of the plurality of LED elements is stored as the characteristic data.

18. An image forming apparatus comprising:
an LED print head having an LED array formed by a plurality of LED elements which are controlled to emit light in accordance with image data and a drive circuit for driving the plurality of LED elements; and
an LED array controller for driving and controlling the LED print head, wherein
the LED array controller includes:
a characteristic data memory for storing a plurality of pieces of characteristic data regarding each of the plurality of LED elements; and
a light emission time correction data calculator for reading out characteristic data of a predetermined LED element and characteristic data of a plurality of LED elements in a predetermined range including the predetermined LED element out of the plurality of pieces of characteristic data from the characteristic data memory, and calculating light emission time correction data for the predetermined LED element on a basis of the characteristic data of the predetermined LED element and the characteristic data regarding each of the plurality of LED elements in the predetermined range.

19. An image forming apparatus comprising:
an LED print head having an LED array formed by a plurality of LED elements which are controlled to emit light in accordance with image data and a drive circuit for driving the plurality of LED elements; and
an LED array controller for driving and controlling the LED print head, wherein
the LED array controller includes:
a characteristic data memory for storing a plurality of pieces of characteristic data regarding each of the plurality of LED elements; and
a light emission time correction data calculator for reading out characteristic data of a predetermined LED element and an average value of characteristic data of a plurality of LED elements in a predetermined range including the predetermined LED element out of the plurality of pieces of characteristic data from the characteristic data memory, and calculating light emission time correction data for the predetermined LED element on a basis of the characteristic data of the predetermined LED element and the average value of the characteristic data regarding each of the plurality of LED elements in the predetermined range.

20. An image forming apparatus comprising:
an LED print head having an LED array formed by a plurality of LED elements which are controlled to emit light in accordance with image data and a drive circuit for driving the plurality of LED elements; and
an LED array controller for driving and controlling the LED print head, wherein
the LED array controller includes:
a characteristic data memory for storing a plurality of pieces of characteristic data regarding each of the plurality of LED elements; and
a light emission time correction data calculator for reading out characteristic data of a predetermined LED element and an average value of characteristic data of all of the plurality of LED elements forming the LED array out of the plurality of pieces of characteristic data from the characteristic data memory, and calculating light emission time correction data for the predetermined LED element on a basis of the characteristic data of the predetermined LED element and the average value of the characteristic data of all of the plurality of LED elements forming the LED array.

21. An image forming apparatus according to claim 13, wherein
the light emission time correction data satisfies the following equation:
Tₙ=a′ₙ+α·(bₙ−Bₐᵥₑ)/Bₐᵥₑ
where Tₙ represents light emission time correction data of the n-th LED element,
a′ₙ represents light emission time reference data of the n-th LED element for making the light quantity for each of the LED element substantially equal,
bₙ represents data regarding a beam of the n-th LED element,
Bₐᵥₑ represents an average value of data regarding beams of all of the LED elements or an average value of data regarding beams of a plurality of LED elements in a predetermined range including the n-th LED element, and
α represents an arithmetic coefficient regarding a beam.

22. An image forming apparatus according to claim 13, wherein
the light emission time correction data satisfies the following equation:
Tₙ=a′ₙ+α·(bₙ−Bₐᵥₑ)/Bₐᵥₑ+β·(cₙ−Cₐᵥₑ)/Cₐᵥₑ
where Tₙ represents light emission time correction data of the n-th LED element,
a′ₙ represents light emission time reference data of the n-th LED element for making the light quantity for each of the LED element substantially equal,
bₙ represents data regarding a beam of the n-th LED element,
Bₐᵥₑ represents an average value of data regarding beams of all of the LED elements or an average value of data regarding beams of a plurality of LED elements in a predetermined range including the n-th LED element,
α represents an arithmetic coefficient regarding a beam,
cₙ represents resolution data of the n-th LED element,
Cₐᵥₑ represents an average value of resolution data of all of LED elements or an average value of resolution data of a plurality of LED elements in a predetermined range including the n-th LED element, and
β represents an arithmetic coefficient regarding resolution.

23. An image forming apparatus comprising:
an LED print head having an LED array formed by a plurality of LED elements which are controlled to emit light in accordance with image data and a drive circuit for driving the plurality of LED elements; and
an LED array controller for driving and controlling the LED print head, wherein
the LED array controller includes:
a characteristic data memory for storing a plurality of pieces of characteristic data regarding each of the plurality of LED elements;
an LED element characteristic data arranger for reading out the characteristic data from the characteristic data memory and arranging the characteristic data for each of the plurality of LED elements; and
a light emission time correction data calculator for calculating light emission time correction data for each of the plurality of LED elements on a basis of the characteristic data arranged for each of the plurality of LED elements by the LED element characteristic data arranger.

24. An image forming apparatus according to claim 23, further comprising:
an LED element characteristic data memory for storing characteristic data arranged for each of the LED elements by the LED element characteristic data arranger.
